(19) United States
(12) Patent Application Publication
(10) Pub. No.: US 2024/0386877 A1
(43) Pub. Date: Nov. 21, 2024

(54) TECHNIQUES AND USER INTERFACES FOR GENERATING SYNTHESIZED SPEECH

(71) Applicant: Apple Inc., Cupertino, CA (US)

(72) Inventors: Eric D. SCHLAKMAN, San Francisco, CA (US); Cooper BARTH, Mountain View, CA (US); James N. CARTWRIGHT, Campbell, CA (US); Ian M. FISCH, Santa Cruz, CA (US); Christopher B. FLEIZACH, Gilroy, CA (US); Gregory F. HUGHES, San Jose, CA (US); Areeba KAMAL, San Francisco, CA (US); Grant P. MALONEY, Santa Cruz, CA (US); Darren C. MINIFIE, Santa Cruz, CA (US); Christopher J. ROMNEY, San Jose, CA (US); Eric T. SEYMOUR, Sonoma, CA (US); Margarita ZAKIROVA, Milpitas, CA (US)

(21) Appl. No.: 18/518,091

(22) Filed: Nov. 22, 2023

Related U.S. Application Data
(60) Provisional application No. 63/466,675, filed on May 15, 2023.

(51) Int. Cl. G10L 13/047; G06F 3/04886; G06F 3/16; G10L 13/033

(52) U.S. Cl. CPC G10L 13/047; G06F 3/04886; G06F 3/167; G10L 13/033

(57) ABSTRACT

The present disclosure generally relates to techniques and interfaces for generating synthesized speech outputs. For example, a user interface for a text-to-speech service can include ranked and/or categorized phrases, which can be selected to enter as text. A synthesized speech output is then generated to deliver any entered text, for example, using a personalized voice model.

### CROSS-REFERENCE TO RELATED APPLICATIONS

This application claims priority to U.S. Provisional Patent Application Ser. No. 63/466,675, entitled “TECHNIQUES AND USER INTERFACES FOR GENERATING SYNTHESIZED SPEECH,” filed on May 15, 2023, the contents of which are hereby incorporated by reference in their entirety.

### FIELD

The present disclosure relates generally to computer user interfaces, and more specifically to techniques for generating synthesized speech outputs.

### BACKGROUND

Computer systems and electronic devices can be used to provide text-to-speech services, which convert text inputs into synthesized (e.g., computer-generated) speech outputs. Such text-to-speech services can assist with verbal communication in many circumstances, including circumstances that limit a person's ability to speak out loud, such as permanent, temporary, complete, or incomplete loss of voice (e.g., due to injury, illness, or other causes) or voluntary vocal rest.

### BRIEF SUMMARY

Some techniques for generating synthesized speech outputs using electronic devices, however, are generally cumbersome and inefficient. For example, some existing techniques use complex and time-consuming user interfaces, which may require multiple inputs (e.g., keystrokes, key presses, clicks, and other inputs) to control and enter text, increasing the amount of time needed and the likelihood of unintended or improper inputs and thereby wasting user time and device energy. This latter consideration is particularly important in battery-operated devices.

Accordingly, the present technique provides electronic devices with faster, more efficient methods and interfaces for generating synthesized speech outputs. Such methods and interfaces optionally complement or replace other methods for generating synthesized speech outputs. Such methods and interfaces reduce the cognitive burden on a user and the amount of time and inputs needed to generate synthesized speech outputs, producing a more efficient human-machine interface. For battery-operated computing devices, such methods and interfaces conserve power and increase the time between battery charges.

Example methods are disclosed herein. An example method includes, at an electronic device having one or more processors and memory, providing a candidate text library, wherein providing the candidate text library includes: generating a ranking of a plurality of candidate text phrases; and providing a plurality of candidate text affordances corresponding to the plurality of candidate text phrases, wherein the plurality of candidate text affordances are sorted based on the ranking of the plurality of candidate text phrases; receiving first text including at least a portion of a first candidate text phrase included in the plurality of candidate text phrases, wherein receiving the first text includes detecting a selection of a first affordance of the plurality of affordances corresponding to the first candidate text phrase; and in response to receiving the first text, initiating output of the first text as a first synthesized speech output.

Example non-transitory computer-readable media are disclosed herein. An example non-transitory computer-readable storage medium stores one or more programs. The one or more programs comprise instructions, which when executed by one or more processors of an electronic device, cause the electronic device to provide a candidate text library, wherein providing the candidate text library includes: generating a ranking of a plurality of candidate text phrases; and providing a plurality of candidate text affordances corresponding to the plurality of candidate text phrases, wherein the plurality of candidate text affordances are sorted based on the ranking of the plurality of candidate text phrases; receive first text including at least a portion of a first candidate text phrase included in the plurality of candidate text phrases, wherein receiving the first text includes detecting a selection of a first affordance of the plurality of affordances corresponding to the first candidate text phrase; and in response to receiving the first text, initiate output of the first text as a first synthesized speech output.

Example transitory computer-readable media are disclosed herein. An example non-transitory computer-readable storage medium stores one or more programs. The one or more programs comprise instructions, which when executed by one or more processors of an electronic device, cause the electronic device to provide a candidate text library, wherein providing the candidate text library includes: generating a ranking of a plurality of candidate text phrases; and providing a plurality of candidate text affordances corresponding to the plurality of candidate text phrases, wherein the plurality of candidate text affordances are sorted based on the ranking of the plurality of candidate text phrases; receive first text including at least a portion of a first candidate text phrase included in the plurality of candidate text phrases, wherein receiving the first text includes detecting a selection of a first affordance of the plurality of affordances corresponding to the first candidate text phrase; and in response to receiving the first text, initiate output of the first text as a first synthesized speech output.

Example electronic devices are disclosed herein. An example electronic device comprises one or more processors; a memory; and one or more programs, where the one or more programs are stored in the memory and configured to be executed by the one or more processors, the one or more programs including instructions for providing a candidate text library, wherein providing the candidate text library includes: generating a ranking of a plurality of candidate text phrases; and providing a plurality of candidate text affordances corresponding to the plurality of candidate text phrases, wherein the plurality of candidate text affordances are sorted based on the ranking of the plurality of candidate text phrases; receiving first text including at least a portion of a first candidate text phrase included in the plurality of candidate text phrases, wherein receiving the first text includes detecting a selection of a first affordance of the plurality of affordances corresponding to the first candidate text phrase; and in response to receiving the first text, initiating output of the first text as a first synthesized speech output.

An example electronic device comprises means for providing a candidate text library, wherein providing the candidate text library includes: generating a ranking of a plurality of candidate text phrases; and providing a plurality of candidate text affordances corresponding to the plurality of candidate text phrases, wherein the plurality of candidate text affordances are sorted based on the ranking of the plurality of candidate text phrases; means for receiving first text including at least a portion of a first candidate text phrase included in the plurality of candidate text phrases, wherein receiving the first text includes detecting a selection of a first affordance of the plurality of affordances corresponding to the first candidate text phrase; and means for, in response to receiving the first text, initiating output of the first text as a first synthesized speech output.

Example methods are disclosed herein. An example method includes, at an electronic device having one or more processors, receiving a first user input requesting a text-to-speech service; in response to receiving the first user input, displaying a text-to-speech user interface including a candidate text library interface, wherein the candidate text library interface includes: one or more phrase affordances respectively corresponding to one or more candidate phrases; and one or more phrase category affordances; receiving, via the text-to-speech user interface, first text; in response to receiving the first text, displaying the first text in the text-to-speech user interface; detecting a second user input requesting output of the first text; and in response to detecting the second user input: generating, using a personalized voice model associated with a first user, a first synthesized speech output of the first text; and initiating output of the first synthesized speech output.

Example non-transitory computer-readable media are disclosed herein. An example non-transitory computer-readable storage medium stores one or more programs. The one or more programs comprise instructions, which when executed by one or more processors of an electronic device, cause the electronic device to receive a first user input requesting a text-to-speech service; in response to receiving the first user input, display a text-to-speech user interface including a candidate text library interface, wherein the candidate text library interface includes: one or more phrase affordances respectively corresponding to one or more candidate phrases; and one or more phrase category affordances; receive, via the text-to-speech user interface, first text; in response to receiving the first text, display the first text in the text-to-speech user interface; detect a second user input requesting output of the first text; and in response to detecting the second user input: generate, using a personalized voice model associated with a first user, a first synthesized speech output of the first text; and initiate output of the first synthesized speech output.

Example transitory computer-readable media are disclosed herein. An example non-transitory computer-readable storage medium stores one or more programs. The one or more programs comprise instructions, which when executed by one or more processors of an electronic device, cause the electronic device to receive a first user input requesting a text-to-speech service; in response to receiving the first user input, display a text-to-speech user interface including a candidate text library interface, wherein the candidate text library interface includes: one or more phrase affordances respectively corresponding to one or more candidate phrases; and one or more phrase category affordances; receive, via the text-to-speech user interface, first text; in response to receiving the first text, display the first text in the text-to-speech user interface; detect a second user input requesting output of the first text; and in response to detecting the second user input: generate, using a personalized voice model associated with a first user, a first synthesized speech output of the first text; and initiate output of the first synthesized speech output.

Example electronic devices are disclosed herein. An example electronic device comprises one or more processors; a memory; and one or more programs, where the one or more programs are stored in the memory and configured to be executed by the one or more processors, the one or more programs including instructions for receiving a first user input requesting a text-to-speech service; in response to receiving the first user input, displaying a text-to-speech user interface including a candidate text library interface, wherein the candidate text library interface includes: one or more phrase affordances respectively corresponding to one or more candidate phrases; and one or more phrase category affordances; receiving, via the text-to-speech user interface, first text; in response to receiving the first text, displaying the first text in the text-to-speech user interface; detecting a second user input requesting output of the first text; and in response to detecting the second user input: generating, using a personalized voice model associated with a first user, a first synthesized speech output of the first text; and initiating output of the first synthesized speech output.

An example electronic device comprises means for receiving a first user input requesting a text-to-speech service; means for, in response to receiving the first user input, displaying a text-to-speech user interface including a candidate text library interface, wherein the candidate text library interface includes: one or more phrase affordances respectively corresponding to one or more candidate phrases; and one or more phrase category affordances; means for receiving, via the text-to-speech user interface, first text; means for, in response to receiving the first text, displaying the first text in the text-to-speech user interface; means for detecting a second user input requesting output of the first text; and means for, in response to detecting the second user input: generating, using a personalized voice model associated with a first user, a first synthesized speech output of the first text; and initiating output of the first synthesized speech output.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for generating synthesized speech outputs, thereby increasing the effectiveness, efficiency, and user satisfaction with such devices. Such methods and interfaces may complement or replace other methods for generating synthesized speech outputs.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIG. 5C illustrates an exemplary diagram of a communication session between electronic devices in accordance with some embodiments.

FIGS. 6A-6W illustrate systems and techniques for generating synthesized speech outputs in accordance with some embodiments.

FIG. 7 is a block diagram illustrating techniques for generating synthesized speech outputs using ranked candidate text phrases in accordance with some embodiments.

FIG. 8 is a block diagram illustrating techniques for generating synthesized speech outputs using categorized candidate text phrases in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for generating synthesized speech outputs. For example, by providing ranked and/or categorized candidate phrases that can be quickly found and selected to enter and convert to synthesized speech, and by providing other intuitive controls for entering, modifying, pausing, and restarting text inputs and speech outputs, the systems and techniques described herein reduce the time, number of inputs, and processing power used to synthesize speech outputs. Such techniques can likewise reduce the cognitive burden on a user who generate synthesized speech outputs, thereby enhancing productivity. Further, such techniques can reduce processor and battery power otherwise wasted on redundant user inputs. Additionally, by generating synthesized speech outputs using a personalized (e.g., user-specific) voice model, the effectiveness of the synthesized speech outputs is improved. For example, in addition to conveying lexical content (e.g., the text being converted to speech), synthesized speech outputs generated using a personalized voice model can convey non-lexical information, such as the identity of the user.

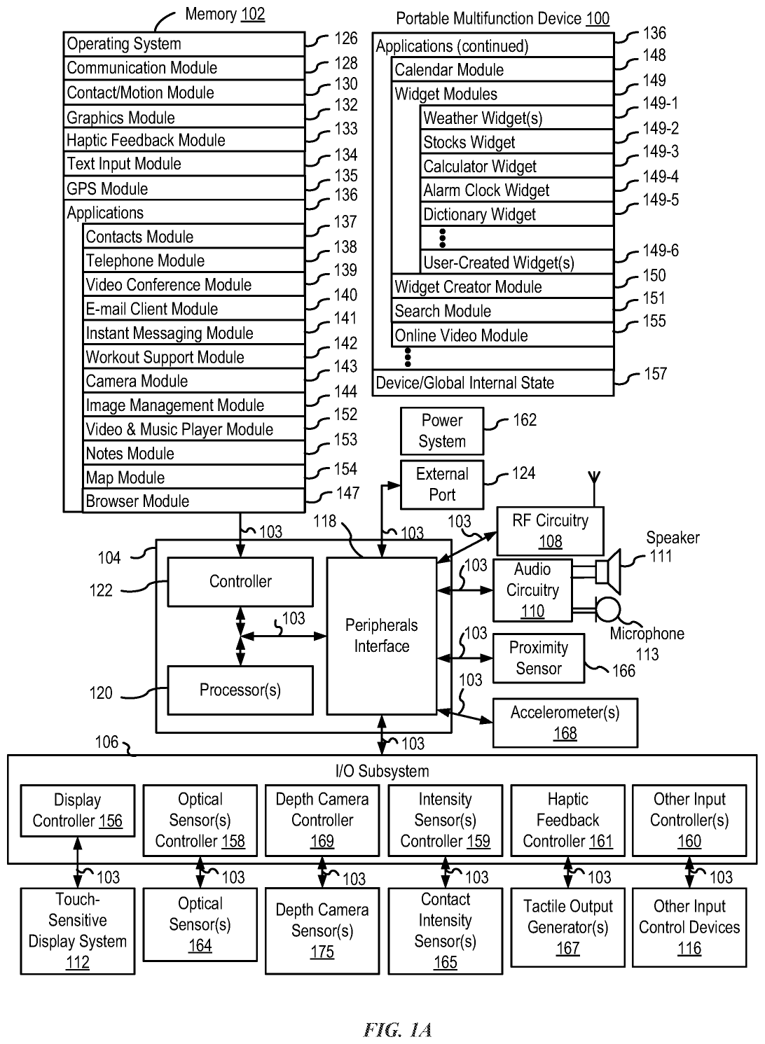

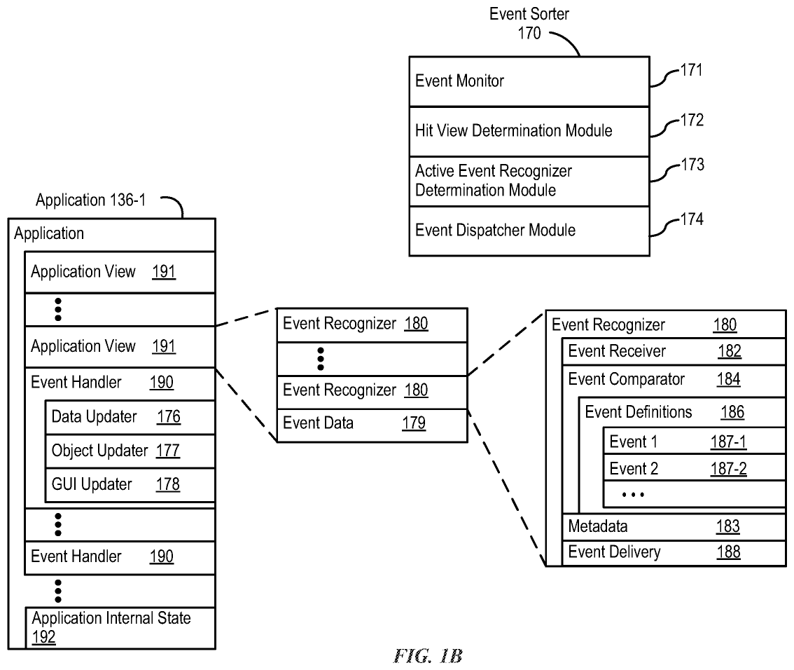

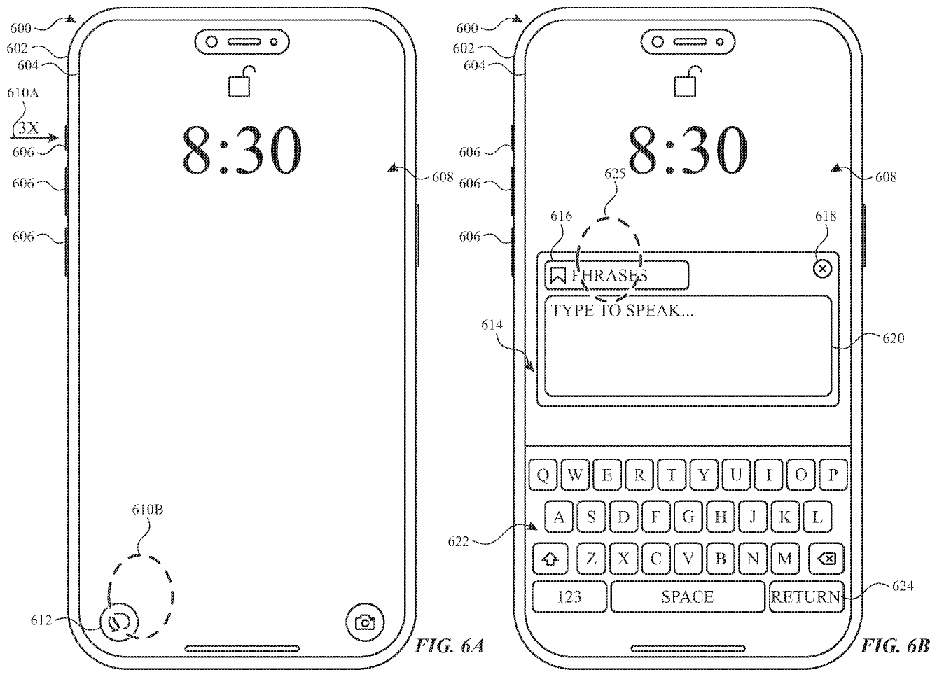

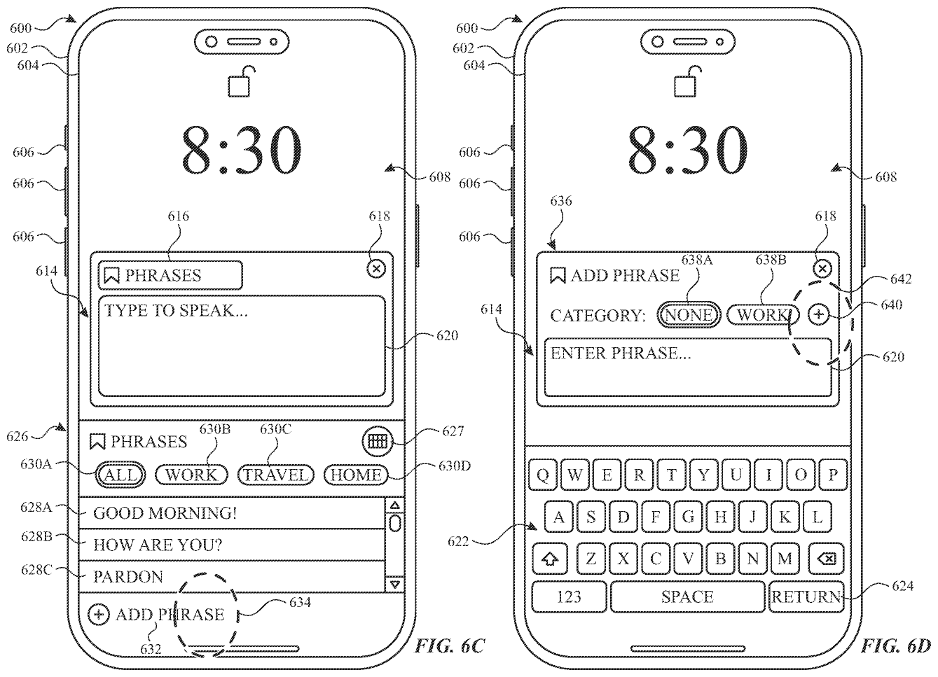

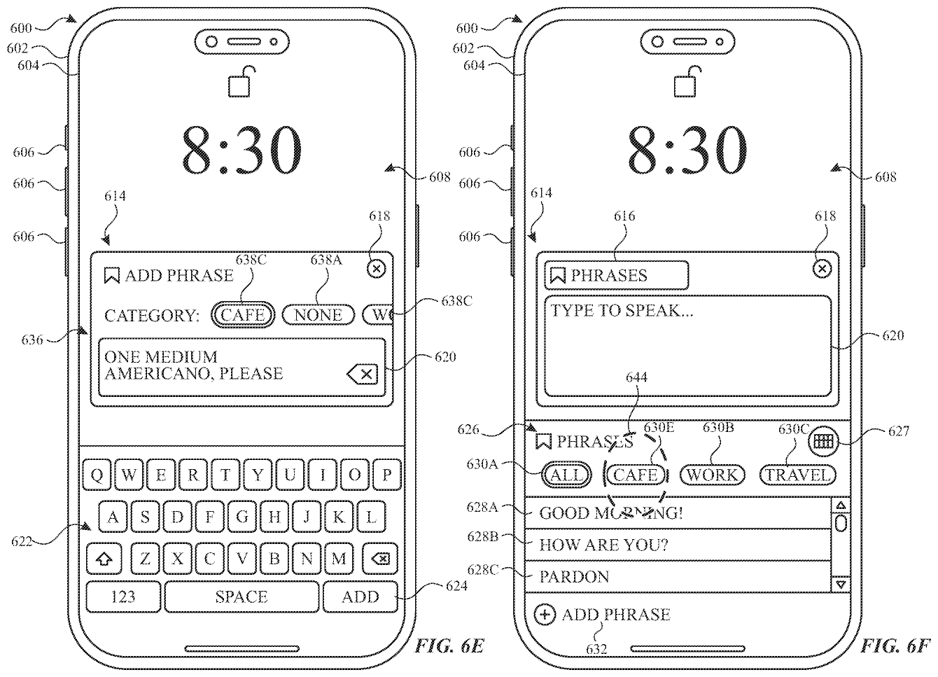

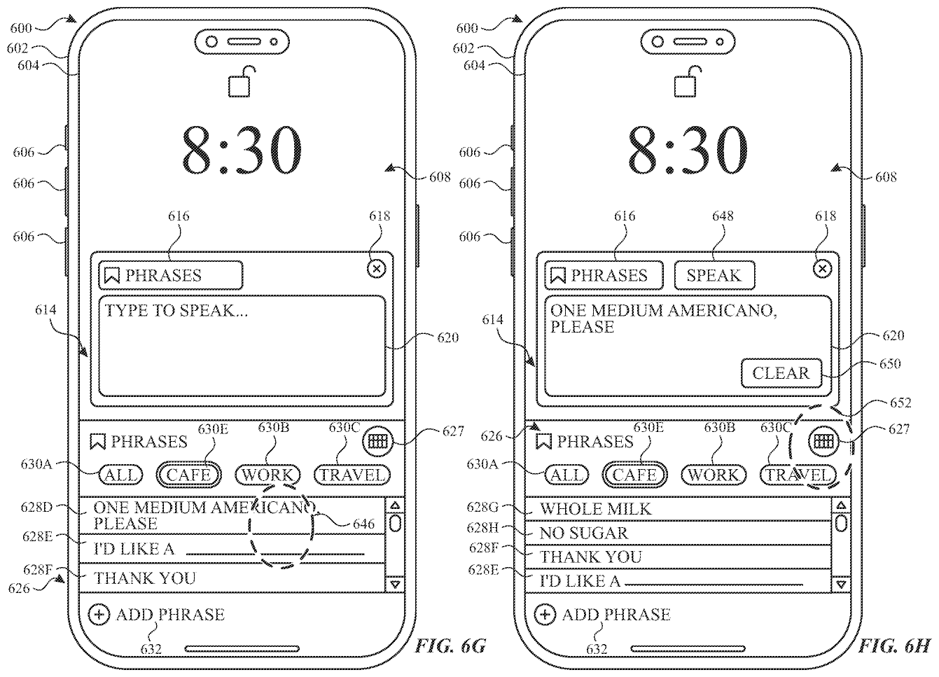

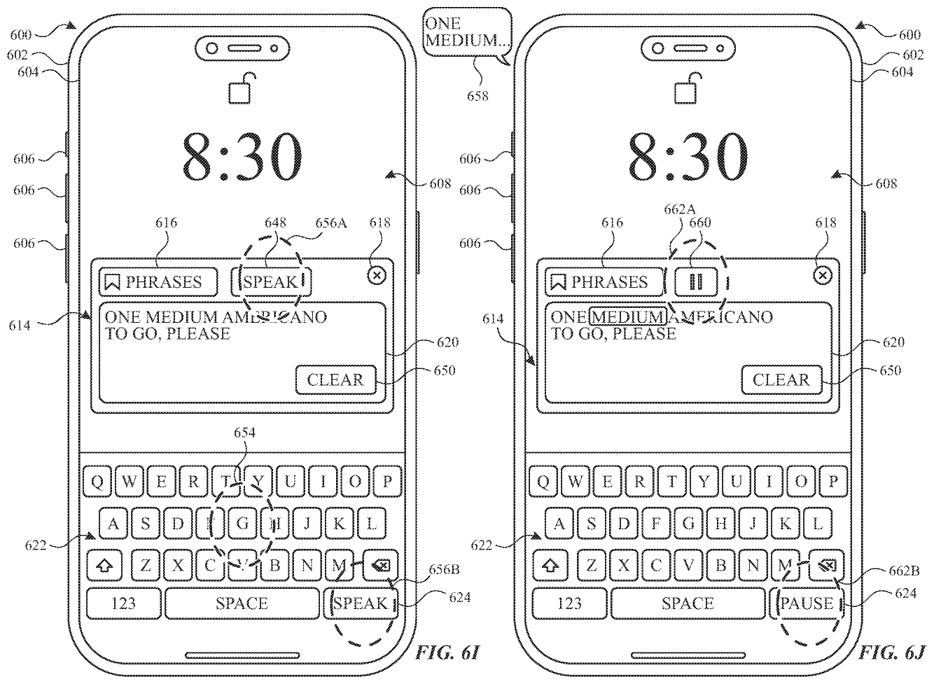

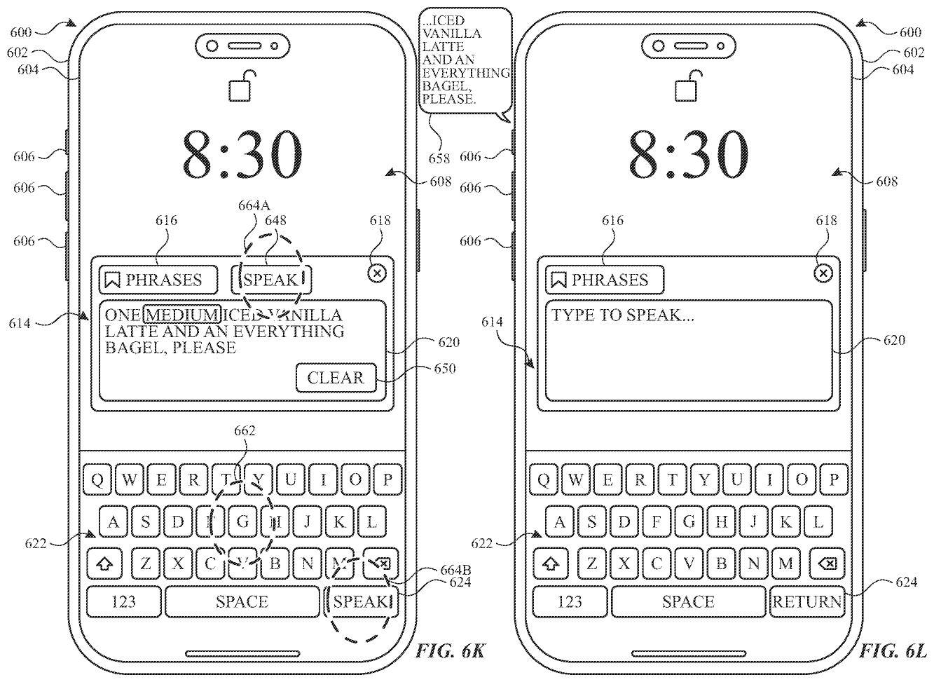

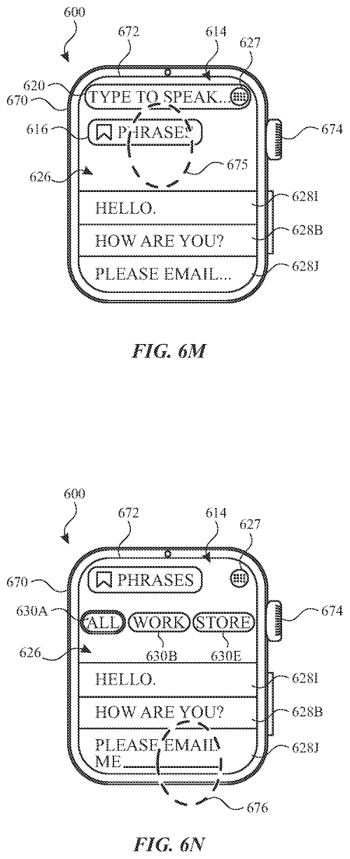

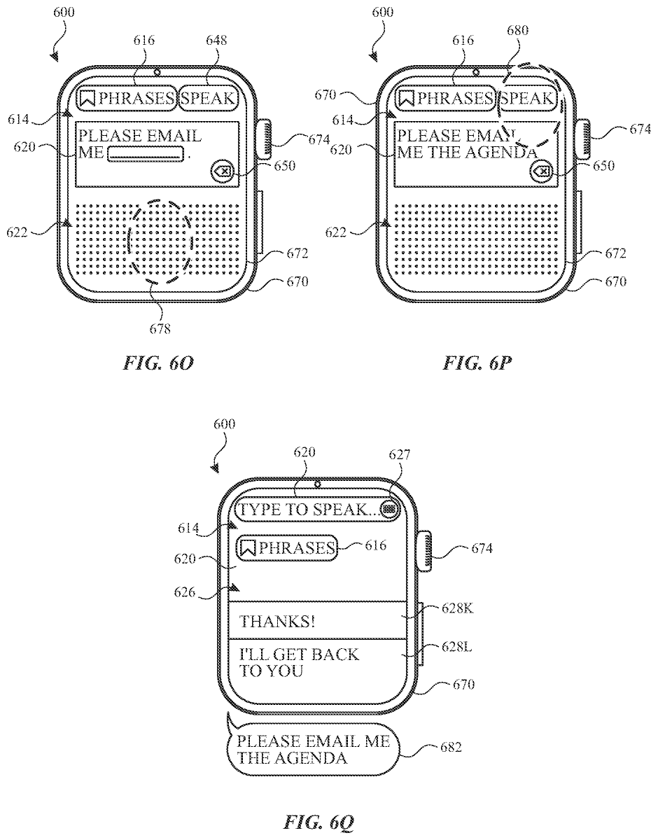

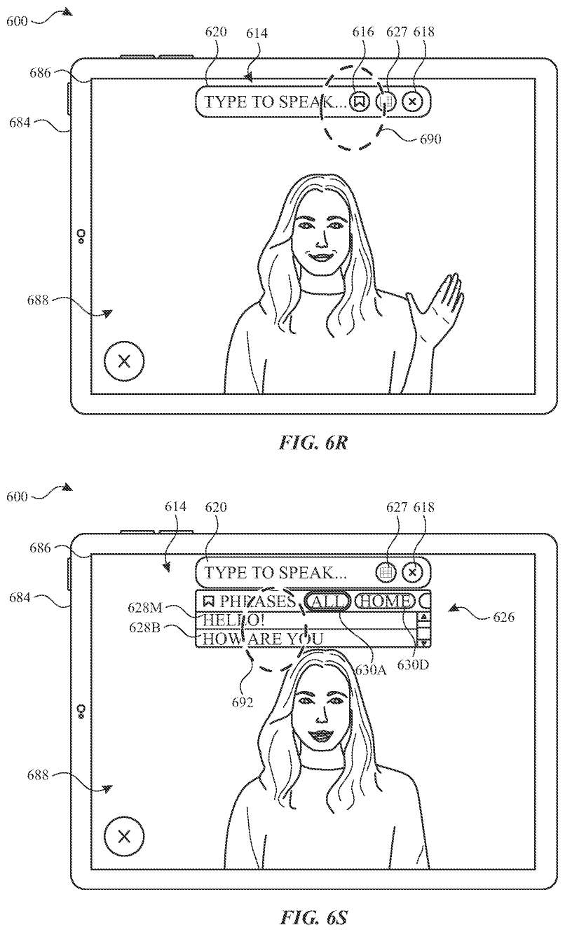

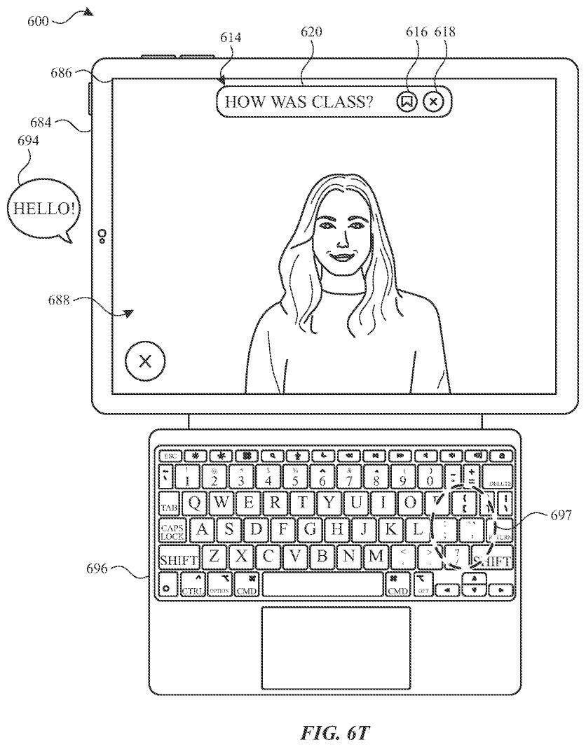

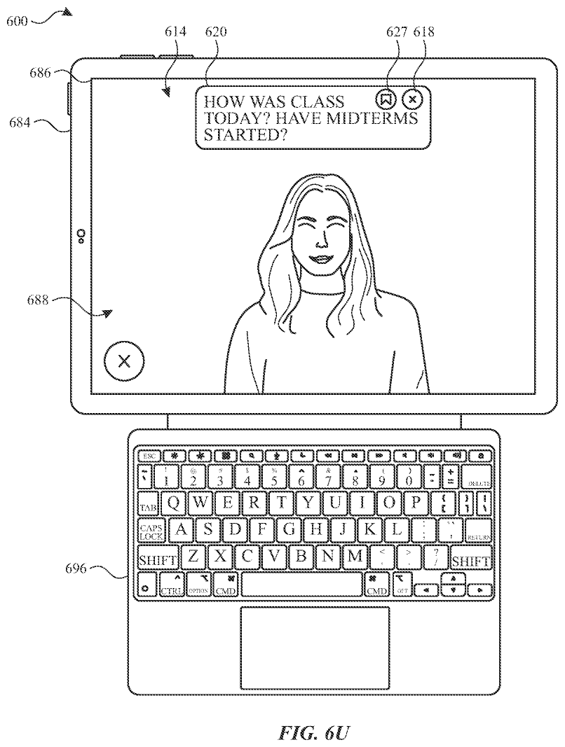

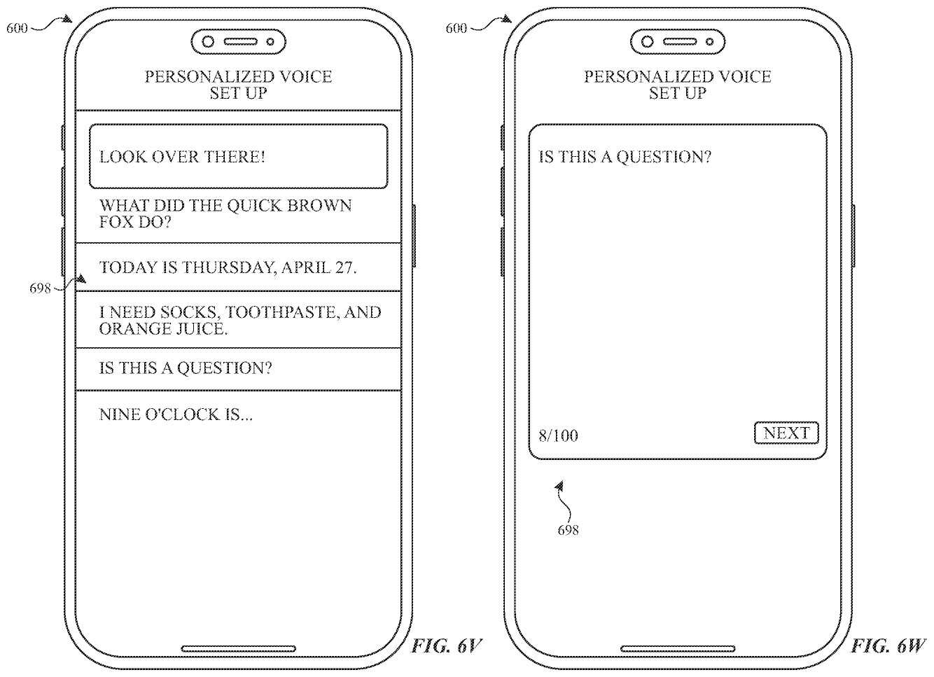

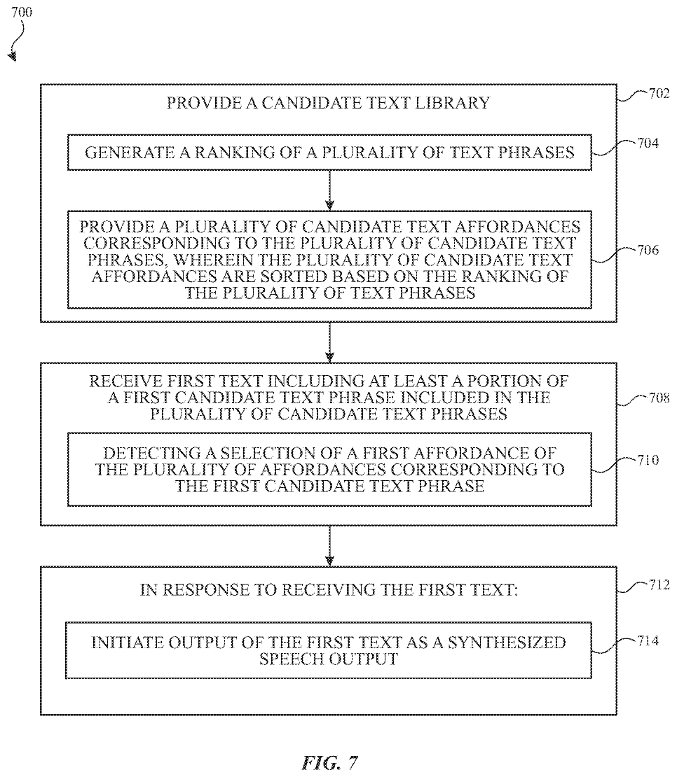

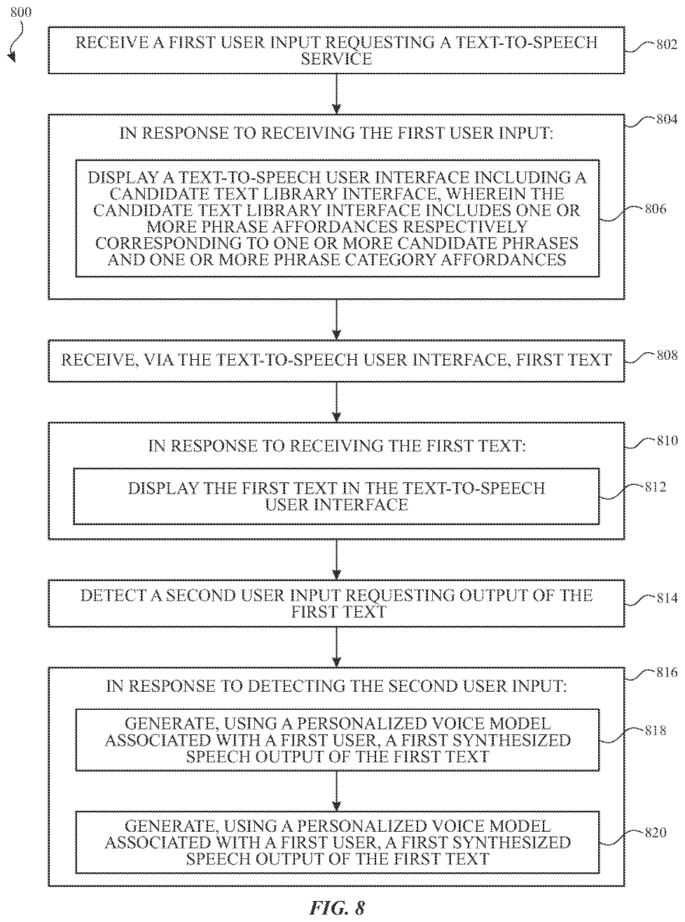

Below, FIGS. 1A-1B, 2, 3, 4A-4B, and 5A-5C provide a description of exemplary devices for performing the techniques for managing event notifications. FIGS. 6A-6W illustrate exemplary systems and techniques for generating synthesized speech outputs. FIG. 7 is a flow diagram illustrating methods of generating synthesized speech outputs using ranked candidate text phrases in accordance with some embodiments. FIG. 8 is a flow diagram illustrating methods of generating synthesized speech outputs using categorized candidate text phrases. The systems and techniques in FIGS. 6A-6W are used to illustrate the processes described below, including the processes in FIGS. 7 and 8.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

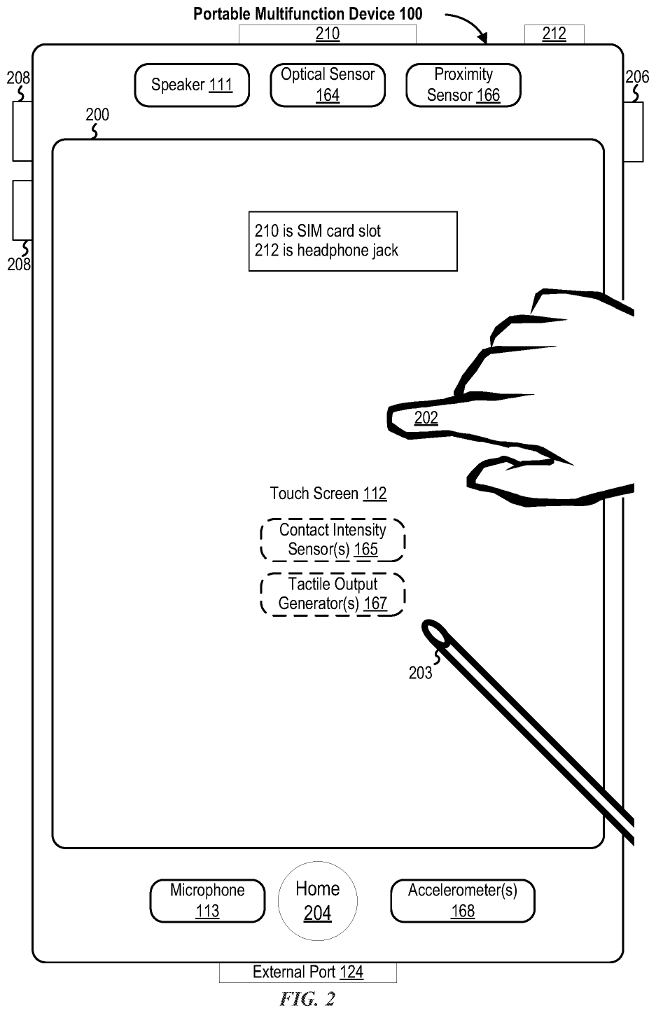

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's car (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

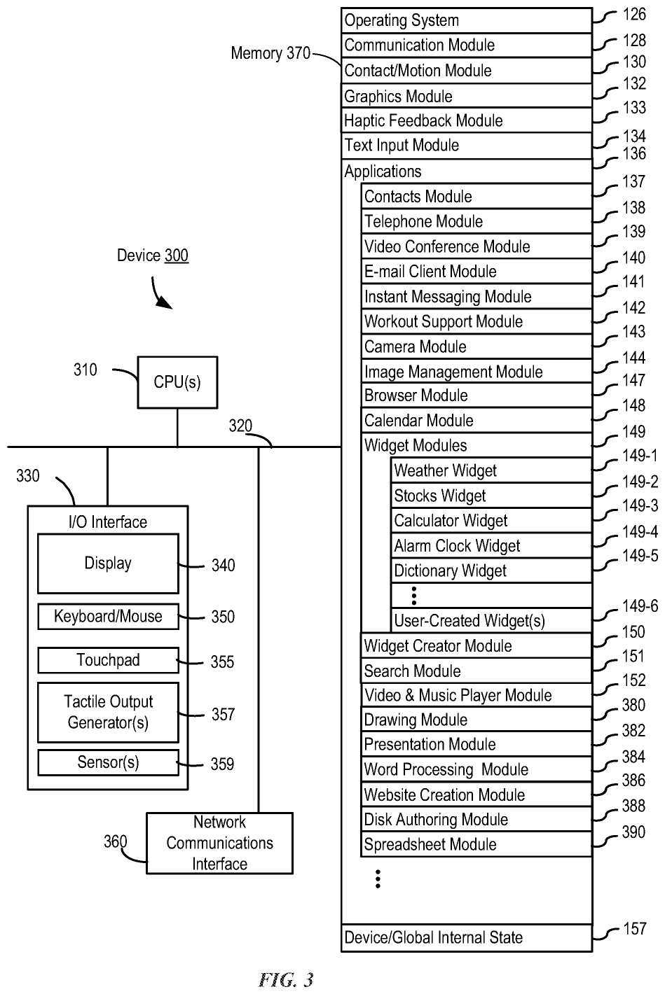

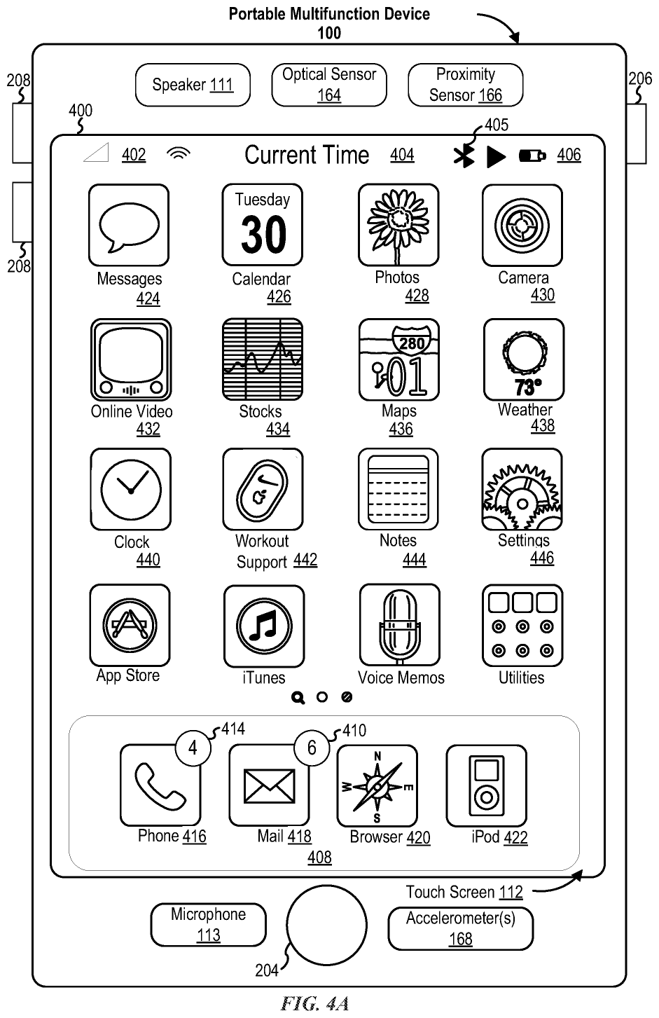

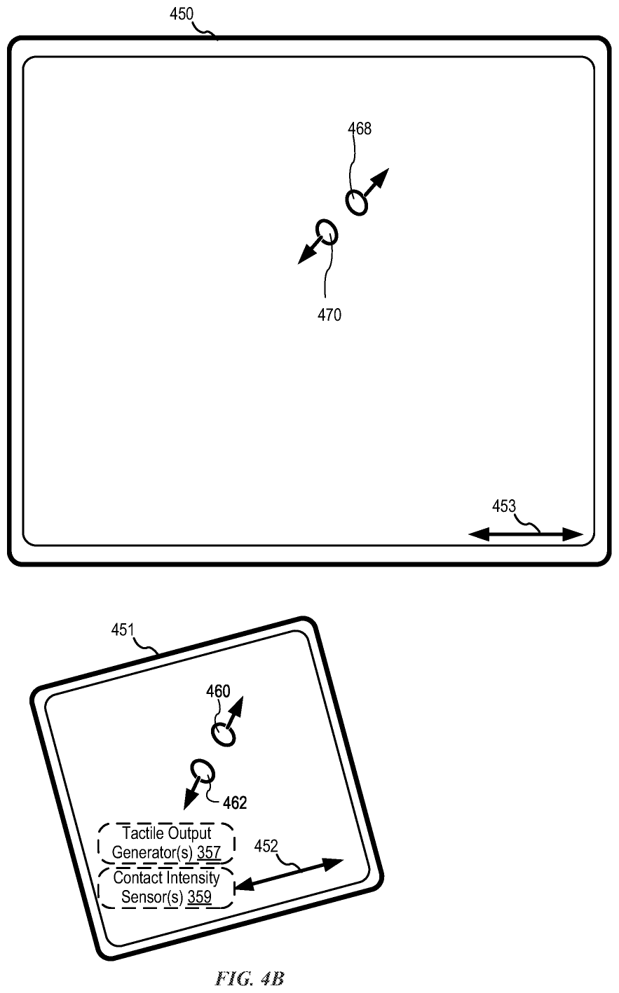

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

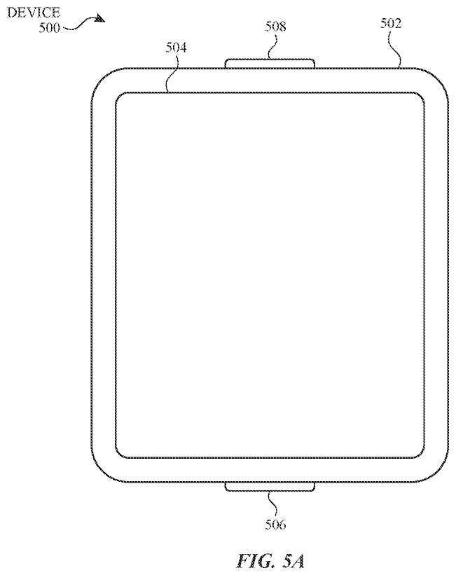

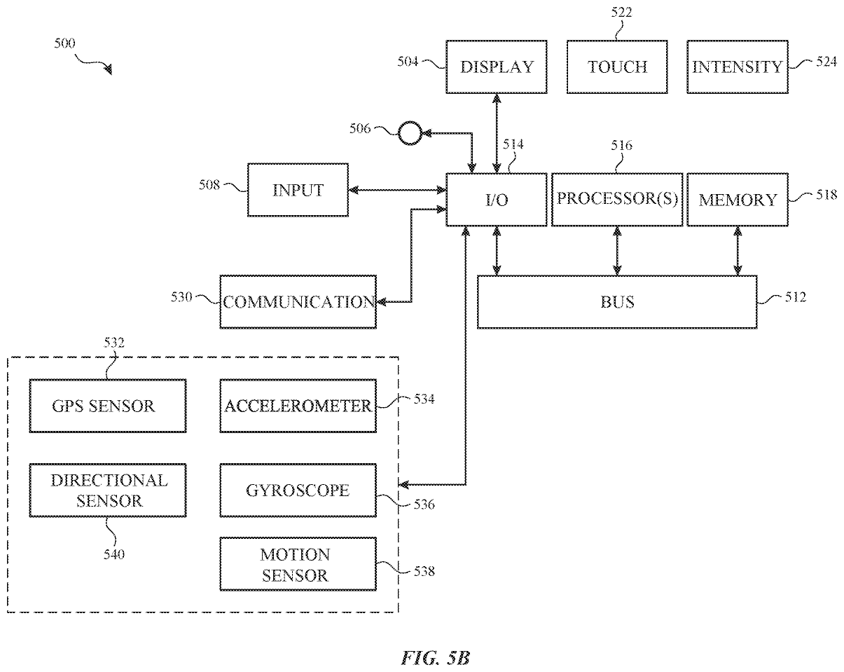

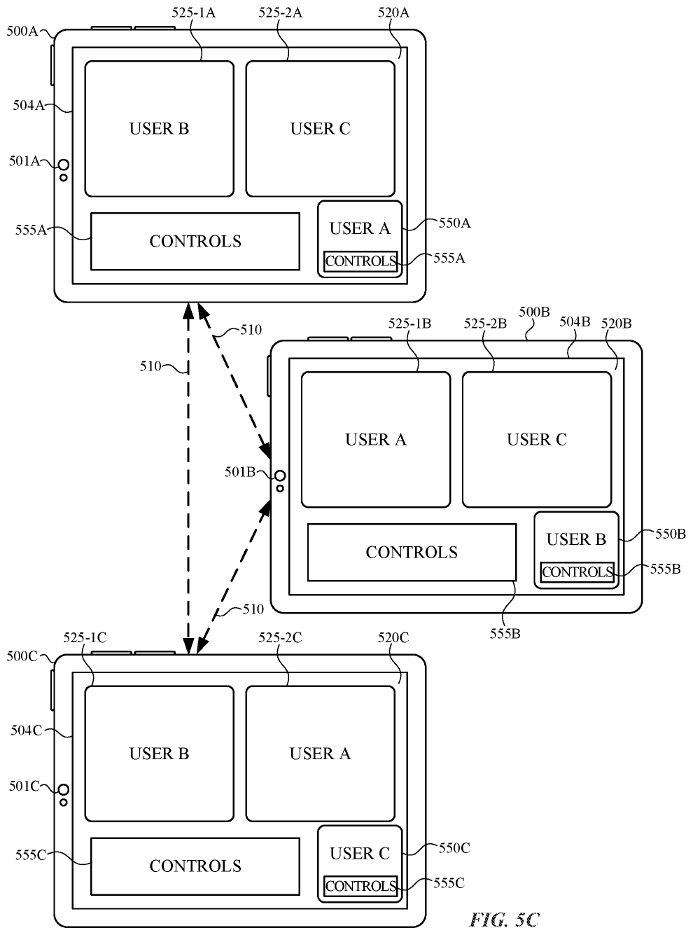

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including methods 700-800 (FIGS. 7-8). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C depicts an exemplary diagram of a communication session between electronic devices 500A, 500B, and 500C. Devices 500A, 500B, and 500C are similar to electronic device 500, and each share with each other one or more data connections 510 such as an Internet connection, Wi-Fi connection, cellular connection, short-range communication connection, and/or any other such data connection or network so as to facilitate real time communication of audio and/or video data between the respective devices for a duration of time. In some embodiments, an exemplary communication session can include a shared-data session whereby data is communicated from one or more of the electronic devices to the other electronic devices to enable concurrent output of respective content at the electronic devices. In some embodiments, an exemplary communication session can include a video conference session whereby audio and/or video data is communicated between devices 500A, 500B, and 500C such that users of the respective devices can engage in real time communication using the electronic devices.

In FIG. 5C, device 500A represents an electronic device associated with User A. Device 500A is in communication (via data connections 510) with devices 500B and 500C, which are associated with User B and User C, respectively. Device 500A includes camera 501A, which is used to capture video data for the communication session, and display 504A (e.g., a touchscreen), which is used to display content associated with the communication session. Device 500A also includes other components, such as a microphone (e.g., 113) for recording audio for the communication session and a speaker (e.g., 111) for outputting audio for the communication session.

Device 500A displays, via display 504A, communication UI 520A, which is a user interface for facilitating a communication session (e.g., a video conference session) between device 500B and device 500C. Communication UI 520A includes video feed 525-1A and video feed 525-2A. Video feed 525-1A is a representation of video data captured at device 500B (e.g., using camera 501B) and communicated from device 500B to devices 500A and 500C during the communication session. Video feed 525-2A is a representation of video data captured at device 500C (e.g., using camera 501C) and communicated from device 500C to devices 500A and 500B during the communication session.

Communication UI 520A includes camera preview 550A, which is a representation of video data captured at device 500A via camera 501A. Camera preview 550A represents to User A the prospective video feed of User A that is displayed at respective devices 500B and 500C.

Communication UI 520A includes one or more controls 555A for controlling one or more aspects of the communication session. For example, controls 555A can include controls for muting audio for the communication session, changing a camera view for the communication session (e.g., changing which camera is used for capturing video for the communication session, adjusting a zoom value), terminating the communication session, applying visual effects to the camera view for the communication session, activating one or more modes associated with the communication session. In some embodiments, one or more controls 555A are optionally displayed in communication UI 520A. In some embodiments, one or more controls 555A are displayed separate from camera preview 550A. In some embodiments, one or more controls 555A are displayed overlaying at least a portion of camera preview 550A.

In FIG. 5C, device 500B represents an electronic device associated with User B, which is in communication (via data connections 510) with devices 500A and 500C. Device 500B includes camera 501B, which is used to capture video data for the communication session, and display 504B (e.g., a touchscreen), which is used to display content associated with the communication session. Device 500B also includes other components, such as a microphone (e.g., 113) for recording audio for the communication session and a speaker (e.g., 111) for outputting audio for the communication session.

Device 500B displays, via touchscreen 504B, communication UI 520B, which is similar to communication UI 520A of device 500A. Communication UI 520B includes video feed 525-1B and video feed 525-2B. Video feed 525-1B is a representation of video data captured at device 500A (e.g., using camera 501A) and communicated from device 500A to devices 500B and 500C during the communication session. Video feed 525-2B is a representation of video data captured at device 500C (e.g., using camera 501C) and communicated from device 500C to devices 500A and 500B during the communication session. Communication UI 520B also includes camera preview 550B, which is a representation of video data captured at device 500B via camera 501B, and one or more controls 555B for controlling one or more aspects of the communication session, similar to controls 555A. Camera preview 550B represents to User B the prospective video feed of User B that is displayed at respective devices 500A and 500C.

In FIG. 5C, device 500C represents an electronic device associated with User C, which is in communication (via data connections 510) with devices 500A and 500B. Device 500C includes camera 501C, which is used to capture video data for the communication session, and display 504C (e.g., a touchscreen), which is used to display content associated with the communication session. Device 500C also includes other components, such as a microphone (e.g., 113) for recording audio for the communication session and a speaker (e.g., 111) for outputting audio for the communication session.

Device 500C displays, via touchscreen 504C, communication UI 520C, which is similar to communication UI 520A of device 500A and communication UI 520B of device 500B. Communication UI 520C includes video feed 525-1C and video feed 525-2C. Video feed 525-1C is a representation of video data captured at device 500B (e.g., using camera 501B) and communicated from device 500B to devices 500A and 500C during the communication session. Video feed 525-2C is a representation of video data captured at device 500A (e.g., using camera 501A) and communicated from device 500A to devices 500B and 500C during the communication session. Communication UI 520C also includes camera preview 550C, which is a representation of video data captured at device 500C via camera 501C, and one or more controls 555C for controlling one or more aspects of the communication session, similar to controls 555A and 555B. Camera preview 550C represents to User C the prospective video feed of User C that is displayed at respective devices 500A and 500B.

While the diagram depicted in FIG. 5C represents a communication session between three electronic devices, the communication session can be established between two or more electronic devices, and the number of devices participating in the communication session can change as electronic devices join or leave the communication session. For example, if one of the electronic devices leaves the communication session, audio and video data from the device that stopped participating in the communication session is no longer represented on the participating devices. For example, if device 500B stops participating in the communication session, there is no data connection 510 between devices 500A and 500C, and no data connection 510 between devices 500C and 500B. Additionally, device 500A does not include video feed 525-1A and device 500C does not include video feed 525-1C. Similarly, if a device joins the communication session, a connection is established between the joining device and the existing devices, and the video and audio data is shared among all devices such that each device is capable of outputting data communicated from the other devices.

The embodiment depicted in FIG. 5C represents a diagram of a communication session between multiple electronic devices, including the example communication sessions depicted in FIGS. 6R-6U. In some embodiments, the communication sessions depicted in FIGS. 6R-6U include two or more electronic devices, even if other electronic devices participating in the communication session are not depicted in the figures.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

In some embodiments, the computer system is in a locked state or an unlocked state. In the locked state, the computer system is powered on and operational but is prevented from performing a predefined set of operations in response to user input. The predefined set of operations optionally includes navigation between user interfaces, activation or deactivation of a predefined set of functions, and activation or deactivation of certain applications. The locked state can be used to prevent unintentional or unauthorized use of some functionality of the computer system or activation or deactivation of some functions on the computer system. In some embodiments, in the unlocked state, the computer system is powered on and operational and is not prevented from performing at least a portion of the predefined set of operations that cannot be performed while in the locked state. When the computer system is in the locked state, the computer system is said to be locked. When the computer system is in the unlocked state, the computer is said to be unlocked. In some embodiments, the computer system in the locked state optionally responds to a limited set of user inputs, including input that corresponds to an attempt to transition the computer system to the unlocked state or input that corresponds to powering the computer system off.

Attention is now directed towards embodiments of user interfaces (“UI”) and associated processes that are implemented on an electronic device, such as portable multifunction device 100, device 300, or device 500.

FIGS. 6A-6W illustrate exemplary systems and user interfaces for generating synthesized speech outputs, in accordance with some embodiments. The user interfaces in these figures are used to illustrate the processes described below, including the processes in FIG. 7 and FIG. 8.

FIGS. 6A-6L illustrates exemplary system 600 for generating synthesized speech outputs as implemented using device 602, a mobile phone device including touch-sensitive display 604 and one or more hardware buttons 606. As illustrated in FIG. 6A, device 602 displays lock screen 608 (e.g., a user interface displayed while device 602 is in a locked state), but device 602 has authenticated an identity of a user (e.g., using a password, passcode, touch (e.g., fingerprint) identification, and/or face identification) and is in an unlocked state, indicated by an open lock icon. While displaying lock screen 608, system 600 detects an input, such as input 610A (e.g., a triple-press of one of the hardware buttons 606) and/or input 610B (e.g., a touch input on touch-sensitive display 604) selecting text-to-speech affordance 612, requesting a text-to-speech service. For example, the text-to-speech service is a service allowing a user to verbally communicate using digitally produced (e.g., synthesized) speech.

As illustrated in FIG. 6B, in response to detecting the input(s) requesting a text-to-speech service (e.g., input 610A and/or input 610B), system 600 launches the text-to-speech service, displaying text-to-speech UI 614 via touch-sensitive display 604. As device 602 was in an authenticated lock state when input 610A and/or input 610B are received, system 600 displays text-to-speech UI 614 overlaying lock screen 608, allowing the user to access the text-to-speech service without fully unlocking device 602. Upon launch, text-to-speech UI 614 includes phrase library affordance 616, cancel affordance 618, text input field 620, and virtual keyboard 622 (including virtual return key 624). Cancel affordance 618 can be selected by the user (e.g., via touch-sensitive display 604) to cease display of text-to-speech UI 614 and exit the text-to-speech service.

At FIG. 6B, system 600 detects (e.g., via touch-sensitive display 604) input 625 selecting phrase library affordance 616. In response to detecting input 625, at FIG. 6C, system 600 updates the display of text-to-speech UI 614, ceasing display of virtual keyboard 622 and initiating display of phrase library UI 626. For example, phrase library UI 626 provides predetermined candidate phrases that can be quickly selected by the user to convert to speech outputs. In some embodiments, the predetermined candidate phrases include sets of one or more words, sub-word fragments, characters, abbreviations, and the like that a user may wish to output as synthesized speech, such as commonly-used phrases (e.g., “Hello,” “Goodbye,” “How are you?,” “Good morning!,” and so forth) and/or contextually relevant phrases (e.g., phrases commonly spoken at restaurants, while traveling, while shopping, at home, at work, and so forth). In some embodiments, the predetermined candidate phrases include predefined candidate phrases (e.g., candidate phrases programmed into the text-to-speech service) and/or user-defined candidate phrases (e.g., candidate text phrases provided by the user, for instance, through text-to-speech UI 614 (e.g., as described below with respect to FIGS. 6D-6E and/or a settings or library configuration UI for the text-to-speech service). In some embodiments, the predetermined candidate phrases include phrases from a cloud-synced phrase library, such as phrases added to the phrase library by the user on a different device.

As illustrated in FIG. 6C, phrase library UI 626 includes candidate phrase affordances 628A, 628B, and 628C for the candidate phrases “Good morning!,” “How are you?,” and “Pardon,” respectively, and can be scrolled to view additional candidate phrase affordances for additional predetermined candidate phrases in the phrase library. In some embodiments, system 600 presents the candidate phrase affordances within phrase library UI in a particular order, determined based on a ranking of the corresponding candidate phrases. For example, system 600 ranks (e.g., prioritizes) the candidate phrases based on contextual information, such as the recency of addition of the corresponding candidate phrases to the phrase library (e.g., prioritizing the display of more recently added phrases), the recency or frequency of use (e.g., prioritizing the display of frequently and/or recently used phrases), a state of conversation (e.g., de-prioritizing phrases after they are used in a current text-to-speech session and/or determining likely next phrases based on previous outputs of the current text-to-speech session), user settings (e.g., prioritizing the display of phrases the user has “liked” or “favorited” or phrases in the user's primary language over a secondary language), and/or other contextual data. For example, as illustrated in FIG. 6C, based on the context of the current time (8:30 AM), candidate phrase affordance 628A for the candidate phrase “Good morning!” is displayed at the top of phrase library UI 626, while a candidate phrase affordance for the candidate phrase “Good night!” is not initially displayed (e.g., a user may need to scroll down through phrase library UI 626 to find the phrase). As another example, based on location information indicating that the user is out in public (e.g., as opposed to at home), candidate phrase affordance 628B for the candidate phrase “How are you?” and candidate phrase affordance 628C for the candidate phrase “Pardon” are prioritized for display in phrase library UI 626.

Phrase library UI 626 also includes phrase category affordances 630A, 630B, 630C, and 630D for the phrase categories “All” (e.g., a category encompassing all of the predetermined candidate phrases in the phrase library), “Work,” “Travel,” and “Home,” respectively, which in some embodiments may be scrolled (e.g., by swiping sideways) to view additional phrase categories. Phrase category affordances 630A, 630B, 630C, and 630D can be selected to view subsets of candidate phrase affordances for candidate phrases associated with those phrase categories, as described in further detail with respect to FIGS. 6F-6G. As illustrated in FIG. 6C, phrase category affordance 630A (“All”) is selected by default. In some embodiments, phrase category affordances 630B, 630C, and 630D can also be ranked based on contextual data (e.g., similarly to the ranking of candidate phrase affordances 628A, 628B, and 628C described above). For example, contextual information such as the time of day, current location, and past user habits, may indicate that the user is currently on the way to work, and accordingly, phrase category affordance 630B is prioritized for display (e.g., immediately next to the default phrase category affordance 630A (“All”)). Phrase library UI 626 further includes keyboard affordance 627, which, when selected, will cause display of phrase library UI 626 to cease and virtual keyboard 622 to be displayed once again (e.g., exiting the phrase library UI).

As illustrated in FIG. 6C, phrase library UI 626 includes new phrase affordance 632 for defining new candidate phrases to add to the phrase library. In response to detecting input 634 selecting new phrase affordance 632, at FIG. 6D, system 600 displays phrase addition UI 636, including cancel affordance 618, text input field 620, and virtual keyboard 622. As illustrated in FIG. 6E, a user can add one or more new candidate phrases, such as “One medium Americano, please” (e.g., a phrase representing the user's usual café order), by entering the new candidate phrases to text input field 620 using virtual keyboard 622. In some embodiments, phrase addition UI 636 may also include a list of suggested phrases, and the user can add one or more new candidate phrases by selecting from the list of suggested phrases.

Phrase addition UI 636 further includes category selection affordance 638A, category selection affordance 638B, and new category affordance 640, allowing a user to (optionally) associate a new candidate phrase with a phrase category. For example, category selection affordance 638A (“None”) provides the option to leave newly-added phrases uncategorized, while selecting category selection affordance 638B would associate a newly-added phrase with the previously-defined phrase category “Work.” As another example, in response to detecting input 642 selecting new category affordance 640, the user can request to define (e.g., using virtual keyboard 622 or an input selecting from a provided list of suggested categories) a new category. As illustrated in FIG. 6E, the user defines a new category, “Café,” (represented by the new selected category selection affordance 638C) to associate with the new candidate phrase “One medium Americano, please.”

As illustrated in FIG. 6F, after adding one or more new candidate phrases associated with the new “Café” phrase category, system 600 updates phrase library UI 626 to display phrase category affordance 630E. In response to detecting input 644, at FIG. 6G, system 600 displays (e.g., filters) phrase library UI 626 including the subset of candidate phrase affordances 628D, 628E, and 628F representing the candidate phrases “One medium Americano, please,” “I'd like a ______,” and “Thank you” (respectively) that are associated with the phrase category “Café.” In some embodiments, system 600 ranks and orders candidate phrase affordance 628D, 628E, and 628F (e.g., the candidate phrase affordances within the selected phrase category) as described with respect to FIG. 6C. The user may scroll phrase library UI 626 to view additional candidate phrase affordances for phrases associated with the phrase category “Café,” but system 600 does not display phrase affordances for phrases not associated with the phrase category “Café” while phrase category affordance 630E is selected.

In response to detecting input 646 selecting phrase affordance 628D, in FIG. 6H, system 600 populates text input field 620 with the candidate phrase “One medium Americano, please.” While text input field 620 is populated with text, system 600 displays confirmation affordance 648 (reading “Speak”), which can be selected to confirm the entered text and begin text-to-speech, and deletion affordance 650 (e.g., reading “Clear”), which can be selected to clear the entered text from text input field 620. Additionally, in some embodiments, system 600 re-ranks the candidate phrases of included in the phrase library and updates phrase library UI 626 accordingly (e.g., as described with respect to FIG. 6C), for example, ceasing display of candidate phrase affordance 628D (e.g., since the phrase “One medium Americano, please” was already selected) and prioritizing display of candidate phrase affordances 628G and 628H (corresponding to the candidate phrases “Whole milk” and “No sugar,” respectively) above the display of candidate phrase affordances 628E and 628F.

In response to detecting input 652 selecting keyboard affordance 627, in FIG. 6I, system 600 ceases displaying phrase library UI 626 and displays virtual keyboard 622. System 600 receives input 654 via virtual keyboard 622, amending the candidate phrase “One medium Americano, please” to add the text “to go,” resulting in the entered text “One medium Americano to go, please.” In addition to adding text via virtual keyboard 622, the user can modify the entered text by deleting portions, rearranging portions, and/or selecting phrase library affordance 616 to add in additional candidate phrases as described above. While text input field 620 is populated with text, system 600 displays virtual keyboard 622 with virtual return key 624 labeled “Speak” (e.g., like confirmation affordance 648), indicating that virtual return key 624 can also be used to confirm the entered text.

Once the user has entered the desired text to text input field 620, the user can initiate text-to-speech by selecting either confirmation affordance 648 or virtual return key 624. In response to detecting input 656A (e.g., selecting confirmation affordance 648) and/or input 656B (e.g., selecting virtual return key 624), in FIG. 6J, system 600 initiates output 658 of the entered text as synthesized speech. The synthesized speech is generated using a voice model to convert the text to an audio output simulating natural speech, for instance, including human-like pronunciation, inflection, dynamic variations, and so forth. While delivering output 658, system 600 visually indicates the portion of the entered text currently being output, for example, highlighting the word “medium” while outputting the synthesized speech of the word “medium.”

In some embodiments, output 658 is generated using a personalized voice model for a user of device 602. For example, the personalized voice model is a text-to-speech voice model trained to produced synthesized speech outputs that simulate speech characteristics e.g., prosody, inflection, intonation, articulation, rate/flow, pitch, overtones, loudness, etc.) of the user (e.g., synthesized speech that sounds like the user's voice). In some embodiments, the personalized voice model is trained at least in part on audio recordings of the user's voice, for example, as provided during a personalized voice model set-up process, such as described below with respect to FIGS. 6V-6W. Accordingly, the synthesized speech of output 658 sounds as though the user were speaking the entered text.

While delivering output 658, system 600 ceases display of confirmation affordance 648, and instead displays pause affordance 660 and updates the display of virtual return key 624 to read “Pause.” As illustrated in FIG. 6J, after delivering the portion of output 658 corresponding the entered text “One medium,” system 600 detects input 662A (e.g., selecting pause affordance 660) and/or input 662B (e.g., selecting virtual return key 624). In response to detecting input 662A and/or 662B, in FIG. 6K, system 600 pauses the delivery of output 658, and additionally ceases display of pause affordance 660, displays confirmation affordance 648, and relabels virtual return key 624 to read “Speak,” indicating that the user can re-start delivery of output 658 by selecting either pause affordance 660 or virtual return key 624.

While delivery of output 658 is paused, system 600 receives input 662 modifying the entered text in text input field 620. For example, using touch-sensitive display 604 to select portions of the entered text in text input field 620 and virtual keyboard 622 to input additional text, the user modifies the entered text to read “One medium iced latte and an everything bagel, please.” As illustrated in FIG. 6K, as the additional text is entered and the overall length of the entered text grows, the appearance of text-to-speech UI 614 can be altered accordingly, increasing the size of text input field 620 to accommodate the longer entered text.

In response to detecting input 664A (e.g., selecting confirmation affordance 648) and/or input 664B (e.g., selecting virtual return key 624), at FIG. 6L, system 600 resumes delivery of output 658 of the modified entered text as synthesized speech. As output 658 was paused after providing the word “medium,” the delivery of output 658 is resumed after the word “medium,” and the portion of the entered text “iced vanilla latte and an everything bagel, please” is output as synthesized speech. In some embodiments, system 600 may also provide an affordance in text-to-speech UI 614 allowing a user to restart the delivery of output 658 (e.g., delivering the entirety of “One medium iced vanilla latte and an everything bagel, please”). In some embodiments, after providing output 658, system 600 provides an option (e.g., in phrase addition UI 636 and/or a settings or library configuration UI for the text-to-speech service) to add the modified phrase “One medium iced vanilla latte and an everything bagel, please” to the candidate phrase library for future use.

In some embodiments, system 600 can receive additional text inputs as described above (e.g., via phrase library UI 626 and/or virtual keyboard 622) while providing output 658, which can be displayed in text input field 620 along with or instead of the text currently being output. In some embodiments, in response to receiving the additional text inputs, system 600 displays confirmation affordance 648 and/or virtual return key 624 reading “Speak,” allowing the user to override (e.g., stop) output 658 and cause system 600 to instead output the newly-entered text.

FIGS. 6M-6Q illustrate exemplary system 600 for generating synthesized speech outputs as implemented using device 670, a smart watch device including touch-sensitive display 672 and hardware button 674. In response to detecting the requesting a text-to-speech service (e.g., as described with respect to FIG. 6A), system 600 launches the text-to-speech service, displaying text-to-speech UI 614. As illustrated in FIG. 6M, upon launch, text-to-speech UI 614 includes phrase library affordance 616, text input field 620, keyboard affordance 627, and phrase library UI 626, which includes candidate phrase affordances 6281, 628B, and 628J for the candidate phrases “Hello,” “How are you?” and “Please email me ______,” respectively. Candidate phrase affordances 628G, 628B, and 628H may be ranked and ordered based on context information (e.g., as discussed with respect to FIG. 6C). In some embodiments, text-to-speech UI 614 is displayed using the entirety of touch-sensitive display 672 (e.g., due to the smaller form factor of device 670 compared to device 602).

In response to detecting input 675 at FIG. 6M selecting phrase library affordance 616, at FIG. 6N, system 600 updates the display of text-to-speech UI 614, ceasing display of text input field 620 and expanding display of phrase library UI 626 to include displaying phrase category affordances 630A, 630B, and 630E for the phrase categories “All,” “Work,” and “Store,” which can be selected to display the subsets of candidate phrase affordances for candidate phrases associated with the various phrase categories (e.g., filtering phrase library UI 626 by category as described with respect to FIGS. 6F-6G).

At FIG. 6N, system 600 detects input 676 selecting candidate phrase affordance 628H for the candidate phrase “Please email me ______,” which is a parameterized (e.g., “fill in the blank”) phrase, where a portion of the phrase (e.g., a portion defining a specific parameter, such as what is being requested via email) remains undefined. In response to detecting input 676, at FIG. 6O, system 600 updates the display of text-to-speech UI 614, displaying text input field 620 populated with the candidate phrase “Please email me ______,” confirmation affordance 648 (e.g., labeled “Speak”), and deletion affordance 650 (e.g., in this embodiment, displayed as a deletion icon). In some embodiments, because the candidate phrase is a parameterized phrase, in response to detecting input 676, system 600 visually indicates (e.g., using highlighting) the undefined portion of the candidate phrase and automatically displays virtual keyboard 622, which can be used to enter text to fill in the undefined portion. As illustrated in FIG. 6O, in some embodiments using device 670 (e.g., a smart watch), virtual keyboard 622 is embodied as a grid used for shorthand character input (e.g., character input via text recognition of gesture inputs drawing individual characters, as opposed to via the selection of individual character affordances). System 600 receives input 678 via virtual keyboard 622, filling in the undefined portion of the parameterized candidate phrase “Please email me ______” to add the text “the agenda,” resulting in the entered text “Please email me the agenda,” shown populated in text input field 620 in FIG. 6P.

At FIG. 6P, system 600 receives input 680 selecting confirmation affordance 648. In response, at FIG. 6Q, system 600 initiates output 682 of the entered text as synthesized speech, for example, using the personalized voice model described above with respect to FIG. 6J and below with respect to FIGS. 6V and 6W. In some embodiments, while delivering output 682, system 600 returns text-to-speech UI 614 to a default view for device 670, e.g., ceasing display of the entered text, virtual keyboard 622, confirmation affordance 648, and/or deletion affordance 650, and resuming display of phrase library UI 626 along with phrase library affordance 616, text input field 620, and keyboard affordance 627. In some embodiments, in response to initiating output 682, system 600 updates the ranking of candidate phrases included in the phrase library based on the contextual information. For example, based on the recent selection and output of the parameterized candidate phrase “Please email me ______” indicating that the user is already in a conversation and that it is unlikely the user will repeat what was already said, system 600 displays phrase library UI 626 with candidate phrase affordances 628K (“Thanks!”) and 628L (“I'll get back to you”) prioritized, based on a determination that the corresponding phrases are likely follow ups. During and after the delivery of output 682, system 600 can update the display of text-to-speech UI 614 and receive further inputs via text-to-speech UI 614 as discussed with respect to FIGS. 6A-6L, for example, pausing, restarting, and/or modifying output 682 or receiving additional text inputs for further text-to-speech outputs.

FIGS. 6R-6U illustrate exemplary system 600 for generating synthesized speech outputs as implemented using device 684, a larger electronic device such as a tablet, laptop, or desktop computer with display 686, and, optionally, one or more input devices (e.g., cameras, touch-sensitive surfaces, buttons, mice, styluses, and/or keyboards). In response to detecting the input requesting a text-to-speech service (e.g., as described with respect to FIG. 6A), system 600 launches the text-to-speech service, displaying text-to-speech UI 614 via display 686 of device 684. While displaying text-to-speech UI 614, system 600 also displays application UI 688 via display 686 of device 684 (e.g., simultaneously with text-to-speech UI 614). As illustrated in FIG. 6R, application UI 688 is a user interface for a video communication application that is currently engaged in a video call with a remote participant. In some embodiments, the input requesting the text-to-speech service is received while already displaying application UI 688 and executing the video communication application and/or the video phone call (e.g., the user can request the text-to-speech service from within the application). As illustrated in FIG. 6R, upon launch, text-to-speech UI 614 includes phrase library affordance 616 (e.g., in this embodiment, displayed as a bookmark icon), text input field 620, keyboard affordance 627, and cancel affordance 618.

At FIG. 6R, system 600 receives input 690 (e.g., a touch or click input) selecting phrase library affordance 616. In response, at FIG. 6S, system 600 updates text-to-speech UI 614 to display phrase library UI 626 including phrase category affordances 630A and 630D for the phrase categories “All” and “Home” and candidate phrase affordances 628M and 628B for the candidate phrases “Hello!” and “How are you?,” respectively. Candidate phrase affordances 628M and 628B may be ranked and ordered based on context information as discussed with respect to FIGS. 6C-6G. In some embodiments, system 600 ceases display of phrase library affordance 616 while displaying phrase library UI 626.

At FIG. 6S, system 600 receives input 692 selecting candidate phrase affordance 628M. In response, at FIG. 6T, system 600 initiates output 694 of the selected candidate phrase as synthesized speech, for example, using the personalized voice model described above with respect to FIG. 6J and below with respect to FIGS. 6V and 6W. In some embodiments, as text-to-speech UI 614 is displayed simultaneously with application UI 688, system 600 provides output 694 to the video communication application, e.g., to transmit to the remote participant as audio of the video call. In some embodiments, system 600 provides output 894 to the video communication application by outputting the audio to an internal microphone of device 684 that the video communication application is using to obtain audio for the video call. In some embodiments, system 600 provides output 894 directly to video communication application, e.g., via an API. Accordingly, a user can invoke text-to-speech UI 614 over another application user interface (e.g., application UI 688) in order to generate synthesized speech outputs for use within the application.

In some embodiments, system 600 initiates output 694 automatically in response to input 692 (e.g., in response to detecting a selection of a candidate phrase affordance (e.g., other than candidate phrase affordances corresponding to parameterized phrases)). During and after the delivery of output 6694, system 600 can update the display of text-to-speech UI 614 and receive further inputs via text-to-speech UI 614 as discussed with respect to FIGS. 6A-6L, for example, pausing, restarting, and/or modifying output 694 or receiving additional text inputs for further text-to-speech outputs. For example, as illustrated in FIG. 6T, while providing output 694, system 600 receives a further text input (e.g., via hardware keyboard 696, as discussed below) beginning to enter text for a subsequent speech output, “How was class?”

As illustrated in FIG. 6T, system 600 detects an attachment (e.g., via a wired or wireless connection) of hardware keyboard 696 to device 684. While hardware keyboard 696 is attached, a user can enter text to text input field 620 using hardware keyboard 696 and/or confirm entered text for output (e.g., as described with respect to FIG. 6J) using a hardware return key of hardware keyboard 696. Accordingly, in response to detecting the attachment of hardware keyboard 696, system 600 updates text-to-speech UI 614, ceasing display of keyboard affordance 627. As illustrated in FIG. 6T, system 600 detects input 697 entering text via hardware keyboard 696, and, at FIG. 6U, system 600 displays the entered text “How was class today? Have midterms started?” in text input field 620.

FIGS. 6V-6W illustrate exemplary user interface 698 for generating (e.g., setting up) a personalized voice model for a particular user that can be used by the text-to-speech service of system 600 to generate synthesized speech outputs. The personalized voice model is a text-to-speech voice model configured to produced synthesized speech outputs that simulate speech characteristics (e.g., prosody, inflection, intonation, articulation, rate/flow, pitch, overtones, loudness, etc.) of the particular user (e.g., synthesized speech that sounds like the user's voice).

To generate the personalized voice model, system 600 obtains a plurality of audio samples of the user's voice and trains a voice model (e.g., a generic text-to-speech engine) on the plurality of audio samples. To obtain the plurality of audio samples, system 600 generates a first plurality of text samples (e.g., a personalized/user-specific training set). In some embodiments, a training corpus (e.g., a generic training set) including plurality of sentence text samples, each of which includes tens or hundreds of different phonemes when read out loud and takes a limited amount of time to read out loud (e.g., approximately seven seconds per sentence), is generated using an algorithm (e.g., a greedy algorithm) and filtered to remove sentences with words longer than four syllables, words in certain categories (e.g., proper names and/or difficult-to-pronounce words). In some embodiments, system 600 then selects (e.g., randomly or semi-randomly) the first plurality of text samples from the training corpus, for example, selecting a set of about 100 sentence text samples including approximately eighty statements (e.g., declarative sentences ending with a period, such as “Today is Thursday, April 27.” or “I need socks, toothpaste, and orange juice.”), ten questions (e.g., sentences ending with a question mark, such as “What did the quick brown fox do?” and “Is this a question?”), and ten exclamations (e.g., sentences ending with an exclamation point, such as “Look over there!”). Although the training corpus may be generated remotely, system 600 selects the first plurality of text samples from the training corpus locally (e.g., on device 602, 670, and/or 684) in order to preserve the privacy and security of the user's personalized training set.

After generating the first plurality of text samples, system 600 outputs the first plurality of text samples via user interface 698, prompting the user to read the text samples out loud to obtain the corresponding plurality of audio samples. As illustrated in FIG. 6V, in some embodiments, system 600 displays multiple text samples at a time (e.g., as a text scroll), highlighting the text sample that the user is being prompted to read. As illustrated in FIG. 6W, in some embodiments, system 600 displays only one text sample at a time (e.g., as a virtual cue card) for the user to read. In some embodiments, system 600 advances the displayed text sample(s) automatically (e.g., in response to the user providing an audio input reading the highlighted text sample out loud), and in some embodiments, system 600 advances the displayed text sample(s) in response to a separate user input (e.g., a selection of a “next” affordance).

System 600 then trains a voice model (e.g., a generic text-to-speech engine) on the plurality of audio samples to generate the personalized voice model. For example, as the first set of text samples produces both a large variety of different phonemes and a variety of intonations (e.g., differences in delivery of statements vs. questions vs. exclamations) when read out loud, the plurality of audio samples can be used to model a variety of speech characteristics (e.g., prosody, inflection, intonation, articulation, rate/flow, pitch, overtones, loudness, etc.) that, together, make the user's voice sound a certain way. Accordingly, by training a voice model on the plurality of audio samples, the generated voice model is trained to output synthesized speech that sounds like the user is speaking. In some embodiments, training the personalized voice model includes determining a noise or static profile from the plurality of audio samples (e.g., to isolate the user's voice from the plurality of audio samples). In some embodiments, training the personalized voice model includes generating a phoneme profile (e.g., modeling how the user pronounces particular phonemes) based on the plurality of audio samples. In some embodiments, training the personalized voice model includes generating a dynamic profile (e.g., modeling how the volume/sound intensity of the user's voice varies during speech) based on the plurality of audio samples.

In some embodiments, system 600 obtains the plurality of audio samples (e.g., via user interface 698), generates the personalized voice model, and stores the personalized voice model locally (e.g., on a user device such as 602, 670, and/or 684) in order to preserve the privacy and security of the user's personalized voice model. In some embodiments, system 600 only generates synthesized speech outputs (e.g., 658, 682, and/or 694) using the personalized voice model in accordance with a determination that system 600 is in an authorized (e.g., unlocked) state. For example, after being in a locked state, system 600 may require an authorization input (e.g., an input providing proper facial identification, fingerprint identification, password entry and/or passcode entry) prior to providing the text-to-speech service and/or implementing the text-to-speech service using the personalized voice model (e.g., as opposed to a generic (e.g., non-user specific) voice model).

In some embodiments, based on a determination of the type(s) of the device(s) implementing system 600, system 600 implements text-to-speech UI 614 differently e.g., as described above with respect to FIGS. 6A-6U. However, while details of system 600 are described above with respect to particular implementing devices (e.g., 602, 670, 684), in some embodiments, details described with respect to one device can be implemented similarly or in the same manner on a different device. Likewise, details of system 600 described with respect to particular implementing devices can be distributed between two or more devices. For example, while the different configurations of text-to-speech UI 614 (e.g., as variously including or not including phrase library affordance 616, cancel affordance 618, text input field 620, virtual keyboard 622, phrase library UI 626, keyboard affordance 627, and/or other affordances/elements) are described with respect to specific devices of device 602, device 670, and device 684, configurations of text-to-speech UI 614 described with respect to device 602 can be displayed on device 670 and/or device 684 and vis versa. As another example, while outputs 658, 682, and 694 are described as being output by the devices at which the text inputs are received, a text input received at a device such as device 670 could be output via a device such as 602, a peripheral device (e.g., speakers and/or headphones), and/or a remote device (e.g., the device of a remote participant).

FIG. 7 is a flow diagram illustrating a method for 700 using a computer system in accordance with some embodiments. Method 700 is performed at an electronic device (e.g., 602, 670, and/or 684) with one or more processors and memory, and, optionally, one or more displays (e.g., 604, 672, and/or 686), input devices (e.g., microphones, touch-sensitive surfaces, hardware buttons (e.g., 606), mice, styluses, and/or keyboards (e.g., 696)), and/or audio output devices (e.g., speakers and/or headphones). Some operations in method 700 are, optionally, combined, the orders of some operations are, optionally, changed, and some operations are, optionally, omitted.

In some embodiments, the electronic device (e.g., 100, 300, 500, and/or 600) is a computer system. The computer system is optionally in communication (e.g., wired communication, wireless communication) with a display generation component and with one or more input devices. The display generation component is configured to provide visual output, such as display via a CRT display, display via an LED display, or display via image projection. In some embodiments, the display generation component is integrated with the computer system. In some embodiments, the display generation component is separate from the computer system. The one or more input devices are configured to receive input, such as a touch-sensitive surface receiving user input. In some embodiments, the one or more input devices are integrated with the computer system. In some embodiments, the one or more input devices are separate from the computer system. Thus, the computer system can transmit, via a wired or wireless connection, data (e.g., image data or video data) to an integrated or external display generation component to visually produce the content (e.g., using a display device) and can receive, a wired or wireless connection, input from the one or more input devices.

As described below, method 700 provides efficient and intuitive techniques for generating synthesized speech outputs. The method reduces the cognitive burden on a user and the processing power used for generating synthesized speech outputs, thereby creating a more efficient human-machine interface. For example, by providing ranked candidate phrases, a user can quickly find and select relevant and/or desirable phrases to convert to synthesized speech, and by and providing other intuitive controls for entering, modifying, pausing, and restarting text inputs and speech outputs, method 700 reduces the time, number of inputs, and effort expended by the user and the electronic device in the process of generating synthesized speech outputs. For battery-operated computing devices, enabling a user to generate synthesized speech outputs faster and more efficiently conserves power and increases the time between battery charges.

At block 702, the electronic device and/or computer system (e.g., 600, 602, 670, and/or 684) provides (e.g., displays; in some embodiments, in response to receiving a request for TTS services; in some embodiments, in response to detecting a selection of a phrase library affordance) a candidate text library (e.g., 626). Providing the candidate text library includes generating (704) a ranking (in some embodiments, the ranking is a weighted ranking based on one or more factors) of a plurality of candidate text phrases and providing (706) a plurality of candidate text affordances (e.g., any of 628A-628M) corresponding to the plurality of candidate text phrases, wherein the plurality of candidate text affordances are sorted based on the ranking of the plurality of candidate text phrases (e.g., as described with respect to FIGS. 6C-6G) (in some embodiments, the plurality of affordances are sorted such that the affordances corresponding to higher-ranked phrases are displayed before (e.g., higher on a list and/or earlier in a navigable menu) and/or with greater visual prominence than the affordances corresponding to at the lower-ranked phrases). For example, displaying the candidate text affordances in the candidate text library based on the raking assists the user in quickly and easily finding and selecting relevant phrases.

In some embodiments, generating the ranking of the plurality of candidate text phrases is based (e.g., at least in part) on current contextual data (e.g., context data indicating the current location, time of day, conversation history, etc.) (e.g., all other factors being equal, the most relevant phrases to the current context are generally ranked higher than other phrases (e.g., while the context data indicates the user is at a restaurant, ranking phrases related to ordering food higher than other phrases; ranking phrases the user typically uses at the current time of day higher than phrases the user doesn't use as often at the current time of day; etc.). For example, based on current contextual data indicating the user is at a coffee shop, candidate text phrases likely to be used in the setting of a café or restaurant can be prioritized for display in the candidate text library over candidate text phrases that are unlikely to be used in the current context.

For example, in some embodiments, generating the ranking of the plurality of candidate text phrases is based (e.g., at least in part) on respective times of addition of the plurality of candidate text phrases to the candidate text library (e.g., all other factors being equal, newly-added phrases are generally ranked higher than older phrases). In some embodiments, generating the ranking of the plurality of candidate text phrases is based (e.g., at least in part) on respective times of use (e.g., when the phrases were last used for TTS and/or were last selected from the candidate text library (if at all)) of the plurality of candidate text phrases (e.g., all other factors being equal, recently used phrases are generally ranked higher than phrases that have been used less recently). In some embodiments, generating the ranking of the plurality of candidate text phrases is based (e.g., at least in part) on respective frequencies of use (e.g., how often the phrases have been used for TTS and/or selected from the candidate text library (if ever)) of the plurality of candidate text phrases (e.g., all other factors being equal, frequently used phrases are generally ranked higher than phrases that have been used less recently). In some embodiments, generating the ranking of the plurality of candidate text phrases is based (e.g., at least in part) on respective user settings (e.g., settings deeming respective phrases “liked” or “favorited” phrases and/or other language preference options (e.g., designating a preferred language and a secondary language)) corresponding to the plurality of candidate text phrases (e.g., all other factors being equal, phrases that the user has expressed a preference for (e.g., by liking, favoriting, or adjusting another setting) are generally ranked higher than other phrases).

In some embodiments, providing the candidate text library includes displaying one or more category affordances (e.g., 630A-630E) corresponding to one or more phrase categories (e.g., the candidate text phrases can be tagged/labeled with different categories, such as “default,” “favorite,” “home,” “work,” “restaurant,” “travel,” etc.). In some embodiments, in response to detecting a selection of a category affordance of the one or more category affordances, the electronic device and/or computer system provides a first set of one or more candidate text affordances of the plurality of candidate text affordances and foregoes providing a second set of one or more candidate text affordances of the plurality of candidate text affordances (e.g., filtering the phrases by the selected category). For example, in response to detecting a selection of a phrase category affordance for a “store” category, the user can filter the displayed candidate text affordances to include phrases associated with the “store” category (e.g., phrases related to purchases, assistive services, and goods) and to exclude other phrases.

In some embodiments, the plurality of candidate text phrases includes at least one predetermined phrase (e.g., a “canned” or default phrase, such as phrases provided by the operating system, text-to-speech application, or an update package). In some embodiments, the plurality of candidate text phrases includes a parameterized phrase (e.g., a “fill in the blanks” phrase), wherein a first portion of the parameterized phrase includes specified text and a second portion of the parameterized phrase is unspecified (in some embodiments, the second portion is completely blank, e.g., “The meeting is at ______” or “I'm going to ______”; in some embodiments, the second portion includes a placeholder or example text that is flagged to the user to change based on their specific needs, e.g., “Hello, [name]” or “I'd like to order [a latte]”). In some embodiments, the plurality of candidate text phrases includes at least one user-defined phrase (e.g., a candidate text phrase provided by a user, e.g., through a text-to-speech UI a settings or library configuration UI for a text-to-speech service).

At block 708, the electronic device and/or computer system receives first text (e.g., the text to be spoken) including at least a portion of a first candidate text phrase included in the plurality of candidate text phrases, wherein receiving the first text includes detecting (710) a selection (e.g., 646, 676, and/or 692) of a first affordance of the plurality of affordances corresponding to the first candidate text phrase (e.g., the user selects a phrase from the candidate text library). For example, the user can select a candidate text phrase to use as-is (e.g., as illustrated in FIG. 6T) or to further modify (e.g., as illustrated in FIGS. 6I and 6O), saving time and effort needed to manually enter (e.g., type in) text.

In some embodiments, receiving the first text includes receiving an input modifying the first candidate text phrase (e.g., an input deleting, rearranging, and/or adding (e.g., via typing and/or selection of another candidate text phrase) to the selected candidate text phrase to produce the first text). In some embodiments, receiving the first text includes receiving a typed input (e.g., a character-by-character text input (e.g., as opposed to the selection of an entire phrase); in some embodiments, via a digital or physical keyboard; in some embodiments, via an input writing out the characters (e.g., a shorthand, longhand, or scribbled input)) providing second text (e.g., as illustrated in FIGS. 6I and 6O). In some embodiments, modifying the first candidate text phrase includes receiving another input modifying or editing the text, such as inputs copying, cutting, pasting, and/or deleting portions of the selected candidate phrase.

In some embodiments where the plurality of candidate text phrases includes a parameterized phrase, in response to detecting a selection of a candidate text affordance corresponding to the parameterized phrase, the electronic device and/or computer system displays a prompt to input text corresponding to the second portion of the parameterized phrase (e.g., as illustrated in FIG. 6O) (e.g., displaying the parameterized phrase with the “blanks” and/or placeholder text indicated to the user, e.g., via underlining or highlighting). In these embodiments, the electronic device and/or computer system receives (e.g., in response to the prompt) a text input corresponding to the second portion of the parameterized phrase; and in response to receiving text corresponding to the second portion of the parameterized phrase, displays the parameterized phrase including the specified text and the text input corresponding to the second portion of the parameterized phrase (e.g., as illustrated in FIG. 6P) (e.g., displaying the parameterized phrase with the “blanks” filled in).

In response to receiving the first text (712) (in some embodiments, and in response to receiving an input requesting the speech output/confirming the first text, such as a selection of a “play” or “speak” affordance or a hardware button press), the electronic device and/or computer system initiates (714) output (e.g., audio playback) of the first text as a first synthesized speech output (e.g., 658, 682, and/or 694). In some embodiments, initiating the output of the first text as the first synthesized speech output is performed in response to detecting an input confirming the first text (e.g., after entering/selecting the text to speak, the user explicitly requests TTS; in some embodiments, a selection of a confirmation affordance such as an “ok,” “play,” and/or “speak” button; in some embodiments, a hardware input, such as pressing an enter or return key on a hardware keyboard).

In some embodiments, the electronic device and/or computer system generates the first synthesized speech output using a personalized voice model associated with a first user. In some embodiments, the personalized voice model is trained to generate synthesized speech outputs that simulate (e.g., sound like) speech characteristics of the first user (e.g., the personalized voice model is trained to generate synthesized speech with characteristics (e.g., prosody, inflection, intonation, articulation, rate/flow, pitch, overtones, loudness, etc.) that mimic the user's speech characteristics). In some embodiments, (e.g., prior to receiving the first text) the personalized voice model is trained at least in part on audio inputs received from the first user (e.g., as described with respect to FIGS. 6V-6W) (e.g., a user-specific training data set; in some embodiments, the audio inputs are received during an initial personalized voice model set-up process (e.g., the user reads predetermined sentences off of cue cards to provide the training data set)).

In some embodiments, while outputting the first text as the first synthesized speech output, the electronic device and/or computer system detects an input requesting to stop playback (e.g., as illustrated in FIG. 6J) and in response to detecting the input requesting to stop playback, ceases the output of the first text as the first synthesized speech output (e.g., as illustrated in FIG. 6K). In some embodiments, after ceasing the output of the first text as the first synthesized speech output, the electronic device and/or computer system detects an input requesting to resume output of the first text, and in response, continues output of the modified first text as a third synthesized speech output (e.g., resuming the output of the first text at the point in the first text where the output was paused). For example, a user can stop the output of a synthesized speech output to wait for a quieter environment, to wait until someone is paying attention, to wait for someone else to speak, or to modify or cancel the spoken output.

In some embodiments, after ceasing the output of the first text as the first synthesized speech output, the electronic device and/or computer system detects an input (e.g., 662) modifying the first text (in some embodiments, an input deleting at least a portion of the first text; in some embodiments, an input inserting new text, such as a typed input and/or a selection of a different phrase from the candidate text library). In some embodiments, after detecting the input modifying the first text, the electronic device and/or computer system detects an input (e.g., 664 and/or 664B) confirming the modified first text and in response to detecting the input confirming the modified first text, initiates output of the modified first text as a third synthesized speech output (e.g., resuming and/or restarting the TTS output with the edited first text).

In some embodiments, while outputting the first text as the first synthesized speech output, the electronic device and/or computer system receives third text. For example, the user can preemptively enter the next text they want to generate as a synthesized speech output, such as selection of another phrase affordance and/or typed or written input, without waiting until the output of the first text is finished. In some embodiments, while outputting the first text as the first synthesized speech output, the electronic device and/or computer system detects an input confirming the third text and in response, ceases output of the first text and initiates output of the third text as a fourth synthesized speech output (e.g., the user can override the initial TTS output and begin a new TTS output).

In some embodiments, the electronic device and/or computer system receives a text input including a second candidate text phrase (in some embodiments, via the candidate text library UI (e.g., an “add phrase” button); in some embodiments, via a settings UI distinct from the TTS UI; in some embodiments, the candidate text phrase was previously input for TTS, and the user is later provided with an option to add the text input as a phrase). In some embodiments, the text input including the second candidate text phrase is received via a settings user interface for a text-to-speech service (e.g., the user can manually add phrases in settings). In some embodiments, the text input including the second candidate text is received via a text input field of the candidate text library (e.g., the user can manually add phrases to the library; in some embodiments, the text input field is displayed in response to selecting a “+” or “add phrase” affordance in the library). In some embodiments, the text input including the second candidate text is received from a second electronic device (e.g., another user device and/or a server (e.g., the candidate text library is cloud-synced)). For example, a user can define and save useful phrases for future use as they see fit, such as a usual coffee order (e.g., “Small cold brew with cream, please,” “I'd like a latte with peppermint syrup”), frequently-made introductions (e.g., “My name is Jeremy,” “My dog's name is Wilson,” “My email is abc@xyz.com”), personalized greetings (e.g., “Howdy, y′all,” “Hey kiddos”), catchphrases, pleasantries, and the like.

In some embodiments, in response to receiving the text input including the second candidate text phrase, the electronic device and/or computer system adds the second candidate text phrase to the candidate text library (e.g., including an accordance corresponding to the first candidate text phrase in the plurality of affordances). In some embodiments, adding the second candidate text phrase to the candidate text library includes, after receiving the text input including the second candidate text phrase, initiating output of the second candidate text phrase as a second synthesized speech output (e.g., the first candidate text phrase is initially entered as an input to the TTS UI) and, after initiating the output of the second candidate text phrase as the second synthesized speech output, providing an affordance (e.g., a “+” or “add to library” affordance; e.g., presented in the TTS UI, in the phrase library UI, and/or in a separate settings UI; in some embodiments, providing one or more affordances for one or more previously-entered phrases) for adding the second candidate text phrase to the candidate text library (in some embodiments, in accordance with a determination that the first candidate is not already included in the library). In these embodiments, adding the second candidate text phrase to the candidate text library is performed in response to detecting a selection of the affordance. For example, after a user generates a synthesized speech output using a typed, written, and or modified candidate phrase text input, the user is later provided with the option to add the previously-output phrase to the plurality of candidate text phrases for future selection from the candidate text library.

In some embodiments, the steps of method 700 (e.g., providing the candidate text library (702), receiving the first text (708), and initiating the output of the first text as the first synthesized speech output (714)) are performed while displaying a lock screen user interface (e.g., as illustrated in FIGS. 6A-6L) (e.g., TTS can be performed while the electronic device is in a locked state; in some embodiments, only performing the steps of method 700 if the device is in an authenticated state (e.g., the lock screen UI is being displayed, but the user's identity has been authenticated, for instance, using face ID, touch ID, a passcode, and/or another device (e.g., a nearby wearable electronic device))). For example, a user can quickly invoke the text-to-speech service even when a device is in a locked state, without waiting for the device to fully unlock and/or needing to fully unlock the device to navigate to and open the text-to-speech service.

In some embodiments, the steps of method 700 (e.g., providing the candidate text library (702), receiving the first text (708), and initiating the output of the first text as the first synthesized speech output (714)) are performed while displaying a user interface (e.g., 688) for an application (e.g., TTS can be performed while in another application context). For example, a user can quickly invoke the text-to-speech service while using another application, without needing to navigate away from or close the other application. In some embodiments, the application is a communication application (e.g., as illustrated in FIGS. 6R-6U) (in some embodiments, a phone call application; in some embodiments, a video call application). In some embodiments, initiating the output of the first text as the first synthesized speech output includes providing the first synthesized speech output to the application (e.g., TTS can be used to provide audio inputs to the application, such as audio inputs for a phone or video call). In some embodiments, providing the first synthesized speech output to the application includes outputting the first synthesized speech output to a microphone of the electronic device (in some embodiments, activating the microphone to detect the audio output). For example, in addition to using synthesized speech outputs for in-person verbal communication, providing the first synthesized speech output to applications allows users to verbally communicate through (e.g., through phone calls, video calls, voice memos, and/or voice chats) or with (e.g., using voice controls) applications.

Note that details of the processes described above with respect to method 700 (e.g., FIG. 7) are also applicable in an analogous manner to the methods described below. For example, method 700 optionally includes one or more of the characteristics of the various methods described below with reference to method 800. For example, displaying the candidate text library interface of method 800 can also include ranking and ordering the included candidate phrases for display as described with respect to method 700. For brevity, these details are not repeated below.

FIG. 8 is a flow diagram illustrating a method for 800 using a computer system in accordance with some embodiments. Method 800 is performed at an electronic device (e.g., 602, 670, and/or 684) with one or more processors and memory, and, optionally, one or more displays (e.g., 604, 672, and/or 686), input devices (e.g., microphones, touch-sensitive surfaces, hardware buttons (e.g., 606), mice, styluses, and/or keyboards (e.g., 696)), and/or audio output devices (e.g., speakers and/or headphones). Some operations in method 800 are, optionally, combined, the orders of some operations are, optionally, changed, and some operations are, optionally, omitted.

In some embodiments, the electronic device (e.g., 100, 300, 500, and/or 600) is a computer system. The computer system is optionally in communication (e.g., wired communication, wireless communication) with a display generation component and with one or more input devices. The display generation component is configured to provide visual output, such as display via a CRT display, display via an LED display, or display via image projection. In some embodiments, the display generation component is integrated with the computer system. In some embodiments, the display generation component is separate from the computer system. The one or more input devices are configured to receive input, such as a touch-sensitive surface receiving user input. In some embodiments, the one or more input devices are integrated with the computer system. In some embodiments, the one or more input devices are separate from the computer system. Thus, the computer system can transmit, via a wired or wireless connection, data (e.g., image data or video data) to an integrated or external display generation component to visually produce the content (e.g., using a display device) and can receive, a wired or wireless connection, input from the one or more input devices.

As described below, method 800 provides efficient and intuitive techniques for generating synthesized speech outputs. The method reduces the cognitive burden on a user and the processing power used for generating synthesized speech outputs, thereby creating a more efficient human-machine interface. For example, by providing categorized candidate phrases, a user can quickly find and select relevant and/or desirable phrases to convert to synthesized speech, and by and providing other intuitive controls for entering, modifying, pausing, and restarting text inputs and speech outputs, method 800 reduces the time, number of inputs, and effort expended by the user and the electronic device in the process of generating synthesized speech outputs. For battery-operated computing devices, enabling a user to generate synthesized speech outputs faster and more efficiently conserves power and increases the time between battery charges. Additionally, generating synthesized speech outputs using a personalized voice model improves the quality of synthesized speech outputs, for example, better conveying non-lexical content and providing a more comfortable user experience.

At block 802, the electronic device and/or computer system (e.g., 600, 602, 670, and/or 684) receives a first user input requesting a text-to-speech service (e.g., a user request to invoke a text-to-speech functionality in order to produce synthesized speech outputs). In some embodiments, the first user input requesting a text-to-speech service includes a hardware button input (e.g., 610A) (e.g., triple-pressing a side button). In some embodiments, the first user input requesting a text-to-speech service includes an input (in some embodiments, via a touch-sensitive display; in some embodiments, using a mouse or other input device) selecting a text-to-speech affordance (e.g., 610B).

In response to receiving the first user input (804), at block 806, the electronic device and/or computer system displays (806) a text-to-speech user interface (e.g., 614) including a candidate text (e.g., phrase) library interface (e.g., 626) (in some embodiments, the candidate text library interface includes a plurality of phrase affordances) that includes one or more phrase affordances (e.g., 628A-628M), respectively corresponding to one or more candidate phrases, and one or more phrase category affordances (e.g., 630A-630E). Displaying phrase affordances and phrase category affordances assists a user in quickly and easily finding and selecting relevant phrases for text-to-speech use.

In some embodiments, the text-to-speech user interface includes a candidate text library affordance (e.g., 616) (e.g., a “phrases” button for expanding the phrase library), and the one or more phrase affordances and the one or more phrase category affordances are displayed (e.g., block 806 is performed) in response to detecting a selection of the candidate text library affordance. In some embodiments, the text-to-speech user interface includes a cancel affordance (e.g., 618) that, when selected, causes displaying the text-to-speech user interface to cease.

In some embodiments, the electronic device and/or computer system detects a selection (e.g., 644) of a first phrase category affordance of the one or more phrase category affordances, wherein the first phrase category affordance corresponds to a first phrase category. In some embodiments, in response to detecting a selection of the first phrase category affordance, the electronic device and/or computer system displays at least a first phrase affordance of the one or more phrase affordances, wherein the candidate phrase corresponding to the first phrase affordance is associated with the first phrase category, and foregoes displaying at least a second phrase affordance of the one or more phrase affordances, wherein the candidate phrase corresponding to the second phrase affordance is not associated with the first phrase category (e.g., as illustrated in FIG. 6G) (e.g., filtering down the phrases to only display phrases associated with the selected category). For example, phrases such as “How was your weekend?,” “Please email me ______,” “My email is abc@xyz.com,” “My extension is x88888,” and “Anyone up for a coffee break?” may be associated with and displayed in response to the selection of a “work” category, while phrases such as “How was school today?,” “We're having ______ for dinner tonight,” “I've fed the dog,” “Rise and shine,” and “Sweet dreams” may be associated with and displayed in response to the selection of a “home” category.

At block 808, the electronic device and/or computer system receives, via the text-to-speech user interface, first text (e.g., the text to be spoken). In some embodiments, receiving the first text includes detecting a selection (e.g., 646, 676, and/or 692) of a third phrase affordance of the one or more phrase affordances, wherein the third phrase affordance corresponds to at least a portion of the first text (e.g., at least part of the first text is entered by selecting a phrase affordance to insert the corresponding phrase). In some embodiments, receiving the first text includes detecting an input (e.g., 697) via a hardware keyboard in communication with the electronic device and/or computer system.

In some embodiments, the electronic device and/or computer system displays a virtual keyboard (e.g., 622) (e.g., displaying a plurality of character affordances for inputting text character-by-character and/or displaying a field (e.g., a grid) for accepting handwritten character inputs). In some embodiments, receiving the first text includes receiving a fourth user input (e.g., 654, 662, and/or 678) via the virtual keyboard (e.g., an input typing and/or hand-writing text character by character). In some embodiments, displaying the virtual keyboard is performed in response to detecting a selection of a keyboard affordance included in the text-to-speech user interface (e.g., the virtual keyboard is displayed at the request of the user). In some embodiments, displaying the virtual keyboard (in some embodiments, and/or an affordance for invoking the virtual keyboard, such as 627) is performed in accordance with a determination that a hardware keyboard is not detected by the electronic device (e.g., as illustrated in FIGS. 6S-6T) (e.g., displaying the virtual keyboard on phones and tablets without connected hardware keyboards and not displaying the virtual keyboard on laptops and phones/tablets with a connected hardware keyboard; in some embodiments, while displaying the virtual keyboard, in accordance with a determination that a hardware keyboard is detected, ceasing display of the virtual keyboard).

In response to receiving the first text (810), the electronic device and/or computer system displays (812) the first text in the text-to-speech user interface (e.g., as illustrated in FIGS. 6H-6K, 6O-6P, and 6T-6U). In some embodiments, the text-to-speech user interface includes a text input field (e.g., 620), and displaying the first text in the text-to-speech user interface includes inserting the first text in the text input field (e.g., the text is initially displayed as editable text in the TTS UI). In some embodiments, receiving the first text (808) includes receiving a third user input to the text entry (e.g., text input) field (in some embodiments, a typed input, e.g., using a virtual or hardware keyboard; in some embodiments, a handwritten (e.g., scribble or shorthand) input, e.g., using a finger or stylus). In some embodiments, the electronic device and/or computer system displays (e.g., initially displays) the text input field with first dimensions (e.g., an initial height and/or width) and, while receiving the first text, modifies the first dimensions based on the first text (e.g., as illustrated in FIGS. 6K and 6U) (e.g., expanding the size of the text input field as text is received; in some embodiments, only modifying the first dimensions once a certain amount of text has been entered; in some embodiments, only modifying the first dimensions to a predetermined maximum size (in some embodiments, adding a scroll option to the text field once the maximum size is reached and further text is entered)). In some embodiments, in response to receiving the first text, the electronic device and/or computer system displays a deletion affordance (e.g., 650) included in the text entry field (e.g., update text entry field to include a “clear all” or “x” affordance once some text is entered).

At block 814, the electronic device and/or computer system detects a second user input (e.g., 656A, 656B, 664A, 664B, and/or 680) requesting output of the first text. In some embodiments, the second user input requesting the output of the first text includes a hardware button press (in some embodiments, a press of an enter/return key on a hardware keyboard; in some embodiments, a press of another button, such as the side button of a phone or tablet). In some embodiments, the second user input requesting the output of the first text includes a selection (in some embodiments, via a touch-sensitive surface of a display; in some embodiments, using a hardware input device such as a mouse or stylus to select a displayed affordance) of a confirmation affordance (e.g., 624 and/or 648) (e.g., a displayed software button). In some embodiments, the confirmation affordance is displayed included in a text entry field of the text-to-speech user interface (e.g., a “speak” or “play” button displayed near the entered text) (e.g., as illustrated in FIGS. 6I, 6K, 6O, and/or 6P). In some embodiments, the confirmation affordance is displayed included in a virtual keyboard of the text-to-speech user interface (e.g., as illustrated in FIGS. 6I and 6K) (e.g., the enter/return key of the virtual keyboard; in some embodiments, the enter/return key of the TTS virtual keyboard is displayed as a “speak” key). In some embodiments, the confirmation affordance is displayed in response to receiving the first text (in some embodiments, the speak button appears after text is entered; in some embodiments, the confirmation affordance is displayed in the location of another button, e.g., changing the “return” button of a virtual keyboard to a “speak” button).

In response to detecting the second user input (816), at block 818, the electronic device and/or computer system generates, using a personalized voice model associated with a first user, a first synthesized speech output of the first text and, at block 820, initiates output (e.g., 658, 682, and/or 694) (e.g., audio playback) of the first synthesized speech output. In some embodiments, the electronic device and/or computer system trains (e.g., prior to receiving the first text) the personalized voice model at least in part on audio inputs received from the first user (e.g., a user-specific training data set; in some embodiments, the audio inputs are received during an initial personalized voice model set-up process (e.g., the user reads predetermined sentences off of cue cards to provide the training data set)). In some embodiments, the personalized voice model is trained to generate synthesized speech outputs that simulate (e.g., sound like) speech characteristics of the first user (e.g., as described with respect to FIGS. 6V-6W) (e.g., the personalized voice model is trained to generate synthesized speech with speech characteristics (e.g., prosody, inflection, intonation, articulation, rate/flow, pitch, overtones, loudness, etc.) that mimic the user's speech characteristics).

In some embodiments, the first text includes at least a first word and a second word and while outputting the first text as the first synthesized speech output, the electronic device and/or computer system displays the first text. In some embodiments, the electronic device and/or computer system visually emphasizes (e.g., highlights, underlines, bolds, italicizes, and/or otherwise changes the appearance of) the first word in the displayed first text while outputting a first portion of the first synthesized speech corresponding to the first word, and the electronic device and/or computer system visually emphasizes the second word in the displayed first text while outputting a second portion of the first synthesized speech output corresponding to the second word. For example, visually emphasizing the words as delivered provides feedback to the user on the state of delivery, for example, confirming that the output is being spoken and allowing the user to track the progress and pause, modify, or cancel the output at the desired time.

In some embodiments, in response to initiating the output of the first text as the first synthesized speech output, the electronic device and/or computer system displays a pause affordance (e.g., 624 and/or 660, as illustrated in FIG. 6J). In some embodiments, the electronic device and/or computer system detects a selection (e.g., 662A and/or 662B) of the pause affordance. In some embodiments, in response to detecting the selection of the pause affordance, the electronic device and/or computer system ceases the output of the first text as the first synthesized speech output, ceases displaying the pause affordance, and displays a play (e.g., confirmation) affordance (e.g., as illustrated in FIG. 6K). For example, while the speech output is paused, the user can modify, clear, and/or restart the delivery of the speech output using the text-to-speech user interface. In some embodiments, after outputting the first text as the first synthesized speech output, the electronic device and/or computer ceases displaying the pause affordance.

In some embodiments, the candidate text library interface includes a phrase addition affordance (e.g., a “+” or “new” affordance). In some embodiments, the electronic device and/or computer system detects a selection of the phrase addition affordance and, in response to detecting a selection of the candidate text library affordance, receives second text (e.g., a user entry of a new phrase to add to the phrase library for future use; in some embodiments, at least a portion of the second text is entered using a hardware or virtual keyboard; in some embodiments, at least a portion of the second text is selected, e.g., from a suggestion menu). In some embodiments, in response to receiving the second text, the electronic device and/or computer system adds a phrase affordance corresponding to the second text to the one or more phrase affordances. For example, a user can add a new phrase to the phrase library

In some embodiments, the electronic device and/or computer system displays a category addition affordance (in some embodiments, in the TTS UI; in some embodiments, in a separate settings UI) and detects a selection of the category addition affordance. In some embodiments, in response to detecting the selection of the category addition affordance, the electronic device and/or computer system receives a fifth user input (in some embodiments, a text input; in some embodiments, a selection from a menu of suggested categories) indicating a new phrase category, receives a sixth user input indicating at least one candidate phrase (in some embodiments, selecting a candidate phrase already included in the library; in some embodiments, entering a new candidate phrase, e.g., by typing or writing), associates the at least one candidate phrase with the new phrase category. For example, the user can define a new category and select preexisting phrases from the phrase library and/or enter new phrases to add to the new category.

Note that details of the processes described above with respect to method 800 (e.g., FIG. 8) are also applicable in an analogous manner to the methods described above. For example, method 800 optionally includes one or more of the characteristics of the various methods described above with reference to method 700. For example, providing the candidate text library of method 700 can also include providing phrase category affordances and the output of the first text of method 700 can be performed using a personalized voice model as described with respect to method 800. For brevity, these details are not repeated herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the generation of synthesized speech outputs. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to provide and suggest candidate text phrases for use generating synthesized speech outputs and/or to train a voice model to deliver synthesized speech outputs with a personalized (e.g., user-specific) voice. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of generating synthesized speech outputs, the present technology can be configured to allow users to select to “opt in” or “opt out” of participation in the collection of personal information data during registration for services or anytime thereafter. In another example, users can select not to provide mood-associated data for generating synthesized speech outputs. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, candidate text phrases can be suggested to users by inferring preferences based on non-personal information data or a bare minimum amount of personal information, such as related content being requested by the device associated with a user, other non-personal information available to the text-to-speech service, or publicly available information. As another example, generating synthesized speech outputs can be performed using a general (e.g., non-user specific) voice model and/or a voice model customized without directly training on a user's voice.

What is claimed is:

1. An electronic device, comprising:
one or more processors;
a memory; and
one or more programs, wherein the one or more programs are stored in the memory and configured to be executed by the one or more processors, the one or more programs including instructions for:
receiving a first user input requesting a text-to-speech service;
in response to receiving the first user input, displaying a text-to-speech user interface including a candidate text library interface, wherein the candidate text library interface includes:
one or more phrase affordances respectively corresponding to one or more candidate phrases; and
one or more phrase category affordances;
receiving, via the text-to-speech user interface, first text;
in response to receiving the first text, displaying the first text in the text-to-speech user interface;
detecting a second user input requesting output of the first text; and
in response to detecting the second user input:
generating, using a personalized voice model associated with a first user, a first synthesized speech output of the first text; and
initiating output of the first synthesized speech output.

2. The electronic device of claim 1, the one or more programs further including instructions for:
training the personalized voice model at least in part on audio inputs received from the first user.

3. The electronic device of claim 1, wherein the personalized voice model is trained to generate synthesized speech outputs that simulate speech characteristics of the first user.

4. The electronic device of claim 1, wherein the first user input requesting a text-to-speech service includes a hardware button input.

5. The electronic device of claim 1, wherein the first user input requesting a text-to-speech service includes an input selecting a text-to-speech affordance.

6. The electronic device of claim 1, wherein the text-to-speech user interface includes a text input field, and wherein displaying the first text in the text-to-speech user interface includes inserting the first text in the text input field.

7. The electronic device of claim 6, the one or more programs further including instructions for:
displaying the text input field with first dimensions; and
while receiving the first text, modifying the first dimensions based on the first text.

8. The electronic device of claim 6, the one or more programs further including instructions for:
in response to receiving the first text, displaying a deletion affordance included in the text input field.

9. The electronic device of claim 6, wherein receiving the first text includes receiving a third user input to the text input field.

10. The electronic device of claim 1, the one or more programs further including instructions for:
displaying a virtual keyboard.

11. The electronic device of claim 10, wherein displaying the virtual keyboard is performed in accordance with a determination that a hardware keyboard is not detected by the electronic device.

12. The electronic device of claim 10, wherein displaying the virtual keyboard is performed in response to detecting a selection of a keyboard affordance included in the text-to-speech user interface.

13. The electronic device of claim 10, wherein receiving the first text includes receiving a fourth user input via the virtual keyboard.

14. The electronic device of claim 1, wherein the text-to-speech user interface includes a candidate text library affordance, and wherein the one or more phrase affordances and the one or more phrase category affordances are displayed in response to detecting a selection of the candidate text library affordance.

15. The electronic device of claim 1, the one or more programs further including instructions for:
detecting a selection of a first phrase category affordance of the one or more phrase category affordances, wherein the first phrase category affordance corresponds to a first phrase category; and
in response to detecting a selection of the first phrase category affordance:
displaying at least a first phrase affordance of the one or more phrase affordances, wherein the candidate phrase corresponding to the first phrase affordance is associated with the first phrase category; and
foregoing displaying at least a second phrase affordance of the one or more phrase affordances, wherein the candidate phrase corresponding to the second phrase affordance is not associated with the first phrase category.

16. The electronic device of claim 1, the one or more programs further including instructions for:
displaying a category addition affordance;
detecting a selection of the category addition affordance; and
in response to detecting the selection of the category addition affordance:
receiving a fifth user input indicating a new phrase category;
receiving a sixth user input indicating at least one candidate phrase; and
associating the at least one candidate phrase with the new phrase category.

17. The electronic device of claim 1, wherein the candidate text library interface includes a phrase addition affordance, and the one or more programs further including instructions for:
detecting a selection of the phrase addition affordance; and
in response to detecting a selection of the phrase addition affordance:
receiving second text; and
in response to receiving the second text, adding a phrase affordance corresponding to the second text to the one or more phrase affordances.

18. The electronic device of claim 1, wherein receiving the first text includes detecting a selection of a third phrase affordance of the one or more phrase affordances, wherein the third phrase affordance corresponds to at least a portion of the first text.

19. The electronic device of claim 1, wherein the text-to-speech user interface includes a cancel affordance that, when selected, causes displaying the text-to-speech user interface to cease.

20. The electronic device of claim 1, wherein the second user input requesting the output of the first text includes a selection of a confirmation affordance.

21. The electronic device of claim 20, wherein the confirmation affordance is displayed included in a text entry field of the text-to-speech user interface.

22. The electronic device of claim 20, the one or more programs further including instructions for:
in response to receiving the first text, displaying the confirmation affordance.

23. The electronic device of claim 20, wherein the confirmation affordance is displayed included in a virtual keyboard of the text-to-speech user interface.

24. The electronic device of claim 1, wherein the second user input requesting the output of the first text includes a hardware button press.

25. The electronic device of claim 1, the one or more programs further including instructions for:
in response to initiating the output of the first text as the first synthesized speech output, displaying a pause affordance.

26. The electronic device of claim 25, the one or more programs further including instructions for:
detecting a selection of the pause affordance; and
in response to detecting the selection of the pause affordance:
cease the output of the first text as the first synthesized speech output;
cease displaying the pause affordance; and
displaying a play affordance.

27. The electronic device of claim 25, the one or more programs further including instructions for:
after outputting the first text as the first synthesized speech output, ceasing displaying the pause affordance.

28. The electronic device of claim 1, wherein the first text includes at least a first word and a second word, and the one or more programs further including instructions for:
while outputting the first text as the first synthesized speech output:
displaying the first text;
while outputting a first portion of the first synthesized speech corresponding to the first word, visually emphasizing the first word in the displayed first text; and
while outputting a second portion of the first synthesized speech output corresponding to the second word, visually emphasizing the second word in the displayed first text.

29. A non-transitory computer-readable storage medium storing one or more programs, the one or more programs comprising instructions, which when executed by one or more processors of a first electronic device, cause the first electronic device to:
receive a first user input requesting a text-to-speech service;
in response to receiving the first user input, display a text-to-speech user interface including a candidate text library interface, wherein the candidate text library interface includes:
one or more phrase affordances respectively corresponding to one or more candidate phrases; and
one or more phrase category affordances;
receive, via the text-to-speech user interface, first text;
in response to receiving the first text, display the first text in the text-to-speech user interface;
detect a second user input requesting output of the first text; and
in response to detecting the second user input:
generate, using a personalized voice model associated with a first user, a first synthesized speech output of the first text; and
initiate output of the first synthesized speech output.

30. A method, comprising:
at an electronic device with a display, one or more processors, and memory:
receiving a first user input requesting a text-to-speech service;
in response to receiving the first user input, displaying a text-to-speech user interface including a candidate text library interface, wherein the candidate text library interface includes:
one or more phrase affordances respectively corresponding to one or more candidate phrases; and
one or more phrase category affordances;
receiving, via the text-to-speech user interface, first text;
in response to receiving the first text, displaying the first text in the text-to-speech user interface;
detecting a second user input requesting output of the first text; and
in response to detecting the second user input:
generating, using a personalized voice model associated with a first user, a first synthesized speech output of the first text; and
initiating output of the first synthesized speech output.
